(19) United States
(12) Patent Application Publication
(10) Pub. No.: US 2006/0014577 A1
(43) Pub. Date: Jan. 19, 2006

(54) Blackjack game with an award modifying feature

(75) Inventor: Roger M. Snow, Las Vegas, NV (US)

Correspondence Address: Richard H. Newman, 1106 Palms Airport Drive, Las Vegas, NV, 89119, US

(73) Assignee: Shuffle Master, Inc.

(21) Appl. No.: 11/225,781

(22) Filed: Sep. 12, 2005

Related U.S. Application Data
(63) Continuation-in-part of application No. 10/770,613, filed on Feb. 2, 2004.

(51) Int. Cl. G06F 17/00

(52) U.S. Cl. 463/12

(57) ABSTRACT

The present invention is directed to a system and method of playing a card game having an award modifying feature. A portion of the ultimate award provided to players of the game at the final outcome is at least partially dependent on satisfying one or more predefined criteria at an intermediate point during play of the game, and can be modified if certain criteria are satisfied upon the outcome of the game.

### CROSS-REFERENCE TO RELATED APPLICATIONS

This application is a continuation-in-part of commonly owned, co-pending U.S. patent application Ser. No. 10/770,613, filed Feb. 2, 2004, the disclosure of which is herein incorporated by reference in its entirety.

### BACKGROUND OF THE INVENTION

1. Field of the Invention

The present invention relates to games of chance, such as card games, and more particularly to a card game, such as blackjack or variants thereof, that facilitates multiple wagering opportunities.

2. Background of the Art

Card games have always been popular as wagering games. The history of card games reaches back into biblical times. One of the most popular card games, especially for gambling or gaming uses is the card game known as blackjack (“Twenty-One” or “21”), the general rules of which are well known. A summary of the rules is provided below.

The basic game of blackjack is played with one or more standard decks of cards wherein each rank of card is associated a numerical value (e.g., royalty is worth 10 points). The object of the game for the players is to be dealt or otherwise develop a hand of cards having a cumulative value closer to 21 than the dealer's hand, provided that no hands exceed 21.

Players are each initially dealt hands consisting of two cards which are displayed face up to compete against the dealer's hand of two cards, with one card of the two cards being displayed face up while the other card is hidden (e.g., face down). The rules of the basic game then provide a round in which each player has the opportunity to maintain the initial hand as dealt (referred to as “sticking” or “standing”) or receive additional cards (referred to as “hitting”). Cards can be added to the hand until the cumulative value of the hand exceeds 21. A player with a cumulative hand value greater than 21 loses the game (referred to as “busting”) and any wager is relinquished.

Once this round has been completed, the dealer reveals the hidden or “hole” card to the players and either stands or hits. In this basic version of the game of blackjack, the dealer does not have the ability to decide whether to stand or hit. Rather, the decision is dictated by the house rules. For example, house rules may dictate that the dealer must typically take another card if the cumulative hand value equals 16 or less and must stand on any hand having a value of 17. In other variants of the game of blackjack, the dealer must take a hit on a “soft” 17, that is, a 17 that was made by more than two cards. Accordingly, if the dealer's hand should eventually exceed 21, the dealer loses the game and the remaining players win and are paid based on their wagers. In the event that both the player and dealer have the same value hands, this is a known as a “push” and the wager is returned to the player.

The house or casino has the advantage because the blackjack player must play and complete their hand before the dealer plays or completes his hand. However, blackjack is relatively simple to understand and is a fast and easy card game for most players to play. Additionally, many players exercise some form of strategy when playing the game which betters their odds of winning. These strategies are often based on assessing a combination of factors such as the player's initial hand value, an estimation of the dealer's hand based on the one visible card and mathematical probability that the hidden card will be of a particular value, along with the chances that taking any additional cards will cause the player or dealer to eventually bust.

While the basic game of blackjack is a relatively fast-paced card game, it is always desirable to offer the players opportunities for variations in the game to maintain their long-term interest. Other betting options are desirable for the Blackjack player other than just varying the size of their wagers. Additional betting options increase the revenue earned by each table. A blackjack game is needed that has wagering opportunities which permit the blackjack player to have a chance to win a large bet (as a regular option or an option after losing a number of conventional bets to the dealer) without the risk of losing a large amount.

Attempts have been made to vary the basic game of blackjack to provide players with additional wagering options as compared to the wagering options in the basic game. For example, some of these variants allow for a player to wager on the dealer's hand value being higher than the player's hand value but not more than 21. Other variants allow the player to wager on the value of the dealer's hidden card. In yet other variants, the players are allowed to make separate wagers on the initial hand with payouts dependent on the rank or suit of the cards dealt. In still other variants, the players are allowed to make separate wagers having payouts that depend on the player's cards and the dealer's viewable card being of a predetermined rank, suit or forming a traditional poker hand such as a straight or flush.

U.S. Pat. No. 5,454,570 to Karal discloses a blackjack card game method wherein a blackjack player has extended wagering opportunities after the blackjack player's hand has reached a desired card count value. Specifically, the blackjack player can bet on whether the dealer will achieve a card count that would be higher (but not greater than 21) than the blackjack player's hand. This supplemental bet or wager by the blackjack player is prior to the dealer revealing the dealer's face down card.

Predetermined odds on the different possible dealer hand combinations are selected by the blackjack player by the selection of the point card value of the dealer's hand. Also, the blackjack player can wager on the point card value of the dealer's only face down card. Furthermore, the blackjack player can bet on the point card value of the third dealer card, etc. The odds presented in the '570 Patent range from 10 to 1 (on an Ace being the dealer down card or the next card to be drawn by the dealer). Picture cards including 10s have a 2 to 1 betting ratio.

A game called the Card Club Bonus Awards at Canterbury Downs in Minnesota which operates under a unique license agreement with the State of Minnesota as follows:
1) The players must make a compulsory wager to play in the game of blackjack, and that compulsory wager allows the house to pay on specific hands or series of hands, so to a degree, the players must make a wager to play in the bonus events.
2) One winning event is a suited blackjack, which pays 2:1.

There are numerous variations of Blackjack that include side bets on various events comprising specific events resulting from player cards only and combinations of player cards and the dealer's up card. Such games include, but are not limited to Lucky Ladies™ game; Ultimate Blackjack; and Lucky Jacks and Queens.

“Lucky Ladies™” is a blackjack variant that involves a side bet wager that is made by the player in a blackjack game against the occurrence of pairs in the player's hand. There is a particularly large bonus in this side bet wager Lucky Ladies™ blackjack variant for the occurrence of a pair of a specific rank and suit (e.g., two Queens of hearts) when the dealer has a blackjack.

U.S. Pat. No. 5,636,843 to Roberts discloses a process and apparatus for making side wagers or proposition (prop) bets in a table or video game. The Roberts game is a method of playing a single card game based upon cards dealt to a player from a deck of playing cards comprising: providing a deck of playing cards; providing a game table with a table top area, a dealer's position, at least one player's position, a first wager area on the table top area adjacent to the player's position and plural second wager areas on the table top area adjacent to the player's position; the player placing a first wager based upon the outcome of the game involving the cards and based upon the winning of the card game, wherein the first wager is placed upon the first area adjacent to the player's position on the table top area; the player placing at least two second prop wagers independent from playing the card game itself and whether said player wins the card game, the second prop wager is based upon the player playing for an occurrence of one or more suit, color, face card or odd and even numbered combinations of all cards that are dealt from the deck to the player during the card game, the second wager is placed upon the second area adjacent to the player's position; the dealer dealing a hand of cards to the player; the dealer selectively dealing or not dealing a card or cards to the player based upon the decision of the player; the dealer paying the player a benefit when the player wins the first wager based upon the winning of the card game; the dealer paying the player a benefit when the player wins any second wager based upon the occurrence of one or more suit, color, face card or odd and even numbered combinations of cards as of the end of the game, independent of whether the player wins the first wager. In addition to these wagering options, some alternative wagering options are described in the specification of the Roberts patent. These options are:
1. Three sevens, comprising the first two cards dealt a player and the dealer up card paying 5000 to 1.
2. The first card received by a player will be a card from a group comprising aces, twos, threes and fours paying 2 to 1.
3. The first two cards received by a player will be cards from the group comprising aces, twos, threes and fours paying 9 to 1.
4. The first two cards received by a player and the dealer up card will be cards from the group comprising aces, twos, threes, and fours paying 27 to 1.
5. The first two cards received by a player will be cards in the same suit from the group comprising aces, twos, threes and fours paying 40 to 1.
6. The first two cards received by a player and the dealer up card will each be cards of the same suit from the group comprising aces, twos, threes, and fours paying 80 to 1.
7. The first card received by a player will be a ten count card (i.e. a ten, jack, queen, or king) paying 2 to 1.
8. The first two cards received by a player and the dealer up card will each be ten count cards paying 27 to 1.
9. A sum of twenty from preselected cards such as a king and a queen or a ten and a jack paying 150 to 1.
10. The first two cards received by a player and the dealer up card will constitute a three card straight flush paying 1000 to 1.

U.S. Pat. No. 6,523,831 (21+3/4); U.S. Pat. No. 6,481,719 (21+3); U.S. Pat. No. 6,371,867 (21+3) and U.S. Pat. No. 6,012,719 (21+3), all to Derek Webb, describe card games that combine the play of blackjack (“21 ”) with a 3-card poker wager or side bet (“21+3” and a variant). Each player places a basic blackjack wager and an optional 3-card poker wager before the cards are dealt. Each player is then dealt a card with the dealer receiving a face-up card. Each player is dealt a second card. At this point, the outcome of each 3-card poker hand is determined, where a player's 3-card poker hand consists of the 2-card hand dealt to that player and the dealer's face-up card. In the (21+3/4) variant, a fourth card (the dealer's down card) is used in the play of the game, with a best 3-card poker hand determined after play of the blackjack game. After settling the poker wagers (in the 21+3 games), the game of blackjack continues in a typical fashion.

U.S. Pat. No. 5,377,993 to Josephs describes a game wherein a modified Twenty-One wagering game is provided. The game offers a wagering option in which a player can increase his wager in advantageous situations. These situations not only envision a Twenty-One payoff but a payoff in accordance with a poker hand formed with certain ones of the player's and dealer's hands and a predetermined poker hand schedule. The bonus events are based upon a combination of player's cards and dealer's cards and no awards are based upon only the player's first two cards after a side bet wager.

U.S. Pat. No. 5,816,575 to Keller describes a method of playing blackjack against a dealer comprising the steps of providing a Blackjack player with a jackpot betting option to make a bet and have a possibility of winning more than one thousand times the bet made by the blackjack player and providing the blackjack player with additional separate betting options to make a bet on receiving at least one card from an initial two cards received by the blackjack player equal to one of a 4 and 5, one of a 3 and 6 and a selected one of a 10, a Jack, a Queen, a King and an Ace. There is a specific available bet on an Ace-Jack in spades and a separate wager on the Ace-Jack of clubs, referred to as a bet on naturals.

U.S. Pat. No. 5,839,730 to Pike describes a method of providing an additional wagering opportunity in a casino game which utilizes standard playing cards, including the steps of a player making a first wager to participate in the casino game; a player optionally making a second wager to participate in a side bet that a predetermined sequence of cards will be dealt to the player, wherein participation in the side bet will not interfere with a player's strategy in the casino game; a dealer dealing a plurality of cards to the player;
(a) if the dealing of the plurality of cards follows a predetermined sequence of cards, the player wins a predetermined amount, wherein the predetermined sequence of cards includes dealing consecutive cards of equal value, each card having an individual value of between two and five, and the combined value of the predetermined sequence is less than twelve; and
(b) the dealer completing the play of the game.

U.S. Pat. No. 6,095,525 to Terminel discloses a method of playing cards between a dealer and at least one other player including the player placing a wager on whether a two card hand will be selected from the group of hands consisting of a 2; a 3; a 4; a 9; a 10; an 11; and a 12; the dealer dealing to the player a two card hand from at least one randomly shuffled deck of cards containing at least one standard playing card deck of fifty two cards; and the dealer paying the player an amount selected from the group consisting of (a) 3 to 2 if, counting the ace only as one, the two cards dealt consist of a 3, 4, 9, 10, or 11; (b) Some amount greater than 3 to 2 if the two cards dealt are a 2; and (c) an amount equal to or greater than option (b) if the two cards dealt are a 12.

U.S. Pat. No. 5,632,485 to Woodland et al. involves a wager on only the player's cards. The patent describes the game as a method of playing a card game comprising the steps of: providing a deck of cards comprising a plurality of different numerical values; providing at least one player with the opportunity to place a single wager on whether the first two cards displayed to said player will be one of a predetermined plurality of two-card winning combinations, and wherein said plurality of two-card winning combinations comprises a first winning combination of cards having a cumulative value of twelve and a second winning combination of cards having a cumulative value of thirteen to sixteen; initially displaying two cards to each player; and resolving each wager by providing a winning payout to a player who placed a correct wager. The wager is on ranges of point counts.

U.S. Pat. No. 5,799,945 to Boylan et al. describes a method of playing a poker-type wagering game whereby, in each round of play, a plurality of outcomes for each respective player to wager against a dealer are available or offered. These outcomes are: (a) that the player has a two card hand of the same suit; (b) that the player has a two card hand which ranks higher than a dealer's two card hand; and (c) that the player has a poker hand with a poker value of greater than a predetermined value, the poker hand being comprised of two card hand of the respective player, the two card hand of the dealer, and a common card. After making an ante bet by each respective player against the dealer for a selected one, or preferably at least two, of the plurality of outcomes, the dealer deals two cards to each respective player and himself and a single card which is designated as the common card. In turn, the dealer then first determines whether each betting player has a respective hand of two cards of the same suit and pays off winning hands. Next, the dealer determines whether a betting player has a respective two card hand which ranks higher than the two card hand of the dealer and pays off winning hands. Finally, the dealer determines whether a betting player has a five card poker hand which has a poker value higher than the predetermined value and pays off winning bets.

U.S. Pat. No. 4,861,041 to Jones discloses a method of including a jackpot component in a live casino table game comprising the steps of: (a) a player wagering a first gaming token to participate in the live casino game, (b) a player wagering a second gaming token to participate in the jackpot component, (c) a dealer dealing a hand of playing cards to the player, (d) if the player's hand comprises a predetermined arrangement of cards, the player wins a preselected amount of the jackpot.

U.S. Pat. No. 5,174,579 to Griffiths describes game play where an additional separate wager is added to a conventional Twenty-One game. The player is wagering on whether the dealer will either bust on his hand or achieve a hand count of exactly 21. The Twenty-One game is played out according to the conventional method of play of the game and the normal winning and losing hands are paid or collected by the dealer. The dealer then reconciles the additional separate wagers based on whether the dealer has either busted or achieved a hand count of exactly 21 during the play of the dealer's hand. This additional wager can be paid according to predetermined odds, such as one-to-one odds or others, as determined by the house.

U.S. Pat. No. 5,288,077 to Jones describes a method of including a jackpot component in a Twenty-One game comprising the steps of: a) a player wagering a first gaming token to participate in the Twenty-One game, b) a player wagering a second gaming token to participate in the jackpot component, c) a dealer dealing a hand of playing cards to the player, d) if the player's hand consists of a predetermined arrangement of cards, the player wins a preselected amount of the jackpot, e) the predetermined arrangements of cards and the preselected winning amounts are shown in pay tables. There is a side bet wager in a blackjack game that includes a payout for a suited blackjack, irrespective of the 10-count card.

U.S. Pat. No. 5,364,105 to Jones describes a Twenty-One game, in which, in addition to his normal wager, a player will have the option of making an additional wager that becomes part of, and makes the player eligible to win, the progressive jackpot. If the player's Twenty-One hand comprises a particular, predetermined arrangement of cards, the player will win all, or part of, the amount showing on the progressive jackpot. In a Twenty-One game using any number of decks of cards, the predetermined winning arrangements of cards preferred in the present invention are an Ace, Two, Three, Four and Five suited; a Two, Three, Four and Five suited; a Four, Five and Six suited; a Four, Five and Six unsuited; an Ace-Jack suited; and optionally any blackjack suited and any blackjack unsuited. In a Twenty-One game that utilizes a six deck shoe, an alternative predetermined winning arrangements of cards preferred in the present invention are Five Three's unsuited; Three Five's suited; a Four, Five and Six suited; a Four, Five and Six unsuited and an Ace-Jack suited.

U.S. Pat. No. 5,538,252 to Green describes how a Twenty-One game is modified by adding one or more Jokers to a standard deck of fifty-two playing cards. In one version, each Joker dealt as one of the first two cards is counted as a variable number so that the resulting first two cards are then valued at a numerical count of an ordinary twenty-one. In this version, any Jokers appearing after the first two cards have a numerical value of one. In a second version, if either the player or the dealer's first two cards are a Joker-Joker combination or a Joker-Ace combination, the hand automatically becomes a blackjack. In any other first two card combinations, the Joker is a non-playable card and must be replaced with a playable card. After the player and the dealer each have two playable cards, their respective hands are then played out. If, during the play of the hands and before the player and the dealer either stand or bust, a Joker is dealt, the Joker has a numerical value of one. In a third version the method of play follows the conventional manner of play of Twenty-One except when a Joker is dealt to either a player or the dealer. The Joker is given a pre-established value during the first two cards and a pre-established value after the first two cards. A PRESS feature, either progressive or multi-level progressive, or another progressive or multi-level progressive jackpot feature may be included.

U.S. Pat. No. 5,829,750 to Booker describes a method of playing a card game of 21 or blackjack is described which allows wagers on the occurrence of a black jack within certain categories of blackjacks, the categories being defined by ranks and suits. A number of possible single hand and multi-hand categories of blackjacks are defined. A player must place a wager on the occurrence of a black jack within one or more specified categories during the course of a standard game of black jack. If a specified hand or specified hands have a black jack which falls within the specified category, the player will win the wager according to a predetermined payout ratio. Bonuses may also be paid for certain categories. The certain categories are shown to include at leas a blackjack, a suited blackjack, a particularly suited blackjack, and matching blackjacks in the player's hand and the dealer's hand.

U.S. Pat. No. 5,673,917 to Vancura discloses a side wager to the game of blackjack or Twenty-One. This side wager allows players to wager on the number of hits that they and/or the dealer will ultimately take. The resolution of the main wager can proceed in the usual fashion, and the game is robust in that it can accommodate common rules variations among casinos. Unlike existing blackjack side wagers, players are actively in control of their fortunes and can play hands as they wish. This added feature affords players considerable excitement and interest, and mathematically, makes the main and side wagers dependent on each other. The game can be played on a standard blackjack playing surface with additional delineated areas for making the side bet.

U.S. Pat. No. 6,341,778 to Lee discloses a method for increasing the payout for the main wager of the game of blackjack or Twenty-One and/or for providing a side bet opportunity during the game of blackjack or Twenty-One which are based upon the point-spread between the players hand and the dealers hand. In one embodiment, a pointspread of 1, 2, 3, or 4 would result in 1×, 1.5×, 2×, or 10× payout, respectively, of the side wager. In another embodiment, a pointspread of 1, 2, 3, or 4 would result in 1×, 2×, 3×, or 5× payout, respectively, of a side bet. In another embodiment, a pointspread of 0, 1, 2, 3, or 4 would result in 0.5×, 1×, 1.5×, 3×, or 5× payout, respectively, of a side bet. The game allows for variations in the rules and for other types of side-betting opportunities while maintaining the excitement of a multiple pointspread payout at the resolution of the hand.

U.S. Pat. No. 5,275,416 to Schorr et al. also discloses a blackjack card game method wherein a blackjack player can bet on the dealer's hand, the blackjack player's hand or for a tie in the point count between the dealer and the blackjack player. The bet for the tie pays 9 to 1, the bet for the blackjack player's hand is even money (1 for 1), and the bet on the dealer's hand is 5 for 6 (five chips can be won on a 6 chip bet).

Over-Under 13 is a side bet game in which a player may place an “over 13” or an “under 13” side bet on a blackjack hand. The player may bet that the player will have an initial two card hand under or over the point count of 13. This side bet game is widely used in casinos in the United States.

D.E.Q. Casinos, Ltd. markets a game known as “Luck Jacks & Queens™” which is played in conjunction with a side bet in a standard blackjack game. Regular blackjack rules apply, and an optional side bet for the side game is made. Combinations of a Jack and a Queen on the first two cards wins a randomly selected prize amount. Suited Queen and Jack combinations on the first two cards can win multiples of the randomly selected prize amounts. The random amount is selected and displayed on a meter attached to the table. There is no pay table.

Many blackjack variants have not been successful for reasons such as the variations unduly decrease the pace of game play, lack exciting betting options or a large jackpot type of payout, or incorporate side wagering options that are not widely utilized by players because they are confusing or their benefits are unknown, minimal or just unappreciated. Thus, there is a need in the art to provide variants of the basic blackjack game which, among other things, include easily understandable and exciting wagering options and large jackpot type payouts without significantly slowing down the game play. Furthermore, there is always a need to provide additional alternatives for people that enjoy games of chance.

### SUMMARY OF THE INVENTION

The present invention provides a method of playing a card game having an award modifying feature, among other things. A portion of the ultimate award provided to players at the final outcome of the game is at least partially dependent on satisfying one or more predefined criteria at an intermediate point during play of the game, and may be modified if certain predefined criteria are satisfied upon the final outcome of the game. Preferably, the award is determined by preset formulas associated with the particular criteria satisfied, which is typically based on the predetermined hand combination achieved, either at the intermediate point or upon the outcome of the game, or both. The card game of the present invention is preferably a variant of the game of blackjack. An underlying game of blackjack or a variant of blackjack is played with an initial wager by a player on the underlying game and an optional wager on a side bet game. The side wager is made before any cards are displayed. The side bet game may be described as:
1) a wagering game having typical blackjack rules as an underlying game;
2) the side bet wager and side bet game are optional;
3) the side bet pays only on specified initial two-card blackjack hands having a count of 20 or 21;
4) the specific hands are:
   Ace and King of the same suit (Payout at 25 to 1)
   Ace and Queen of the same suit (Payout at 20 to 1)
   Ace and Jack of the same suit (Payout at 15 to 1)
   Ace and 10 of the same suit (Payout at 10 to 1)
   Any blackjack with cards (Ace and 10-count card) of different suits (Payout at 5 to 1), and
   Any (hard or soft) count of 20 (Payout at 2 to 1).

In addition to the foregoing, the rules of the game may provide an additional potential payout (bonus effect) such that the bonus on the player's cards (or any other bonus event) is increased (usually multiplied, but possibly a fixed amount) when the specific bonus event or bonus hand is obtained and the dealer busts. Preferably, the bonus will be at least doubled when the dealer busts. The effect may be to increase or decrease the size of the win on the bonus, preferably to increase the size of the bonus.

In one embodiment, the present invention is directed to method of playing a game having an award modifying feature including the steps of wagering a monetary amount on a card game involving a player playing against a dealer; playing the card game until an intermediate condition is reached, wherein the intermediate condition includes providing the player and the dealer with one or more cards to form a player's intermediate hand and a dealer's intermediate hand, respectively; providing an intermediate award to the player if the player's intermediate hand satisfies one or more first predefined criteria, wherein the intermediate award is determined by a predetermined set of rules; playing the card game until a final outcome is reached, wherein upon reaching the final outcome the player forms a player's final hand and the dealer forms a dealer's final hand; and modifying the intermediate award to provide a final award if the dealer's final hand satisfies one or more second predefined criteria, wherein the relationship between the final award and the intermediate award is determined by one or more mathematical formulas associated with at least the second satisfied predefined criteria.

The step in the aforementioned method of wagering a monetary amount on a card game involving a player playing against a dealer may further include wagering a first amount having an outcome dependent on satisfying the first predefined criteria in the intermediate condition and wagering a second amount having an outcome dependent on the final outcome of the game.

The step in the aforementioned method may further include determining if the player's intermediate hand is equivalent to an automatic winning blackjack hand comprising an ace card and a second card having a numerical value of ten in accordance with the rules of blackjack and determining the rank and suit of the cards in the player's intermediate hand.

In one alternative embodiment, the one or more first predefined criteria are satisfied if the player's intermediate hand is determined to be a winning blackjack hand comprising an ace and a second card of the same suit. In another alternative embodiment, the one or more first predefined criteria are satisfied if the player's intermediate hand is determined to be a winning blackjack hand.

The step in the aforementioned method of providing an intermediate award to the player if the player's intermediate hand satisfies one or more first predefined criteria, wherein the intermediate award is determined by a predetermined set of rules, may further include determining the intermediate award by multiplying the first amount by a predetermined multiplier according to the rank of the second card in the player's intermediate hand.

The predetermined multiplier may be determined according to a payout table. An exemplary payout table is shown below:

| Player's intermediate hand | Payout |
|---|---|
| Ace and King of the same suit | 25 to 1 |
| Ace and Queen of the same suit | 20 to 1 |
| Ace and Jack of the same suit | 15 to 1 |
| Ace and 10 of the same suit | 10 to 1 |
| Any blackjack | 5 to 1 |

The step in the aforementioned method of playing the card game until a final outcome is reached, wherein upon reaching the final outcome the player forms a player's final hand and the dealer forms a dealer's final hand may further include playing a game of blackjack until a final outcome is reached and the player's final hand and the dealer's final hand are formed.

The step in the aforementioned method of modifying the intermediate award to provide a final award if the dealer's final hand satisfies one or more second predefined criteria, wherein the relationship between the final award and the intermediate award is determined by one or more mathematical formulas associated with at least the second satisfied predefined criteria, may further include modifying the intermediate award if the cumulative numerical value of the dealer's final hand is greater than twenty-one.

In alternative embodiments, the final award is a multiple of the intermediate award, such as double the monetary value of the intermediate award.

The step in the aforementioned method of modifying the intermediate award to provide a final award if the dealer's final hand satisfies one or more second predefined criteria, wherein the relationship between the final award and the intermediate award is determined by one or more mathematical formulas associated with at least the second satisfied predefined criteria, may further include modifying the intermediate award if the cumulative numerical value of the dealer's final hand is equal to twenty-six.

The step in the aforementioned method of wagering a monetary amount on a card game involving a player playing against a dealer may further include wagering a first amount having an outcome dependent on satisfying the first predefined criteria in the intermediate condition, wagering a second amount having an outcome dependent on the final outcome of the game and wagering a third amount having an outcome dependent on the player's intermediate hand having a cumulative value of either twenty or twenty-one in accordance with the rules of blackjack.

The aforementioned method of the present invention may include the step of providing an additional award being twice the value of the third amount if the player's intermediate hand has a cumulative value of either twenty or twenty-one. In this embodiment, the step of playing the card game until a final outcome is reached, wherein upon reaching the final outcome the player forms a player's final hand and the dealer forms a dealer's final hand, may further include playing a game of blackjack until a final outcome is reached and the player's final hand and the dealer's final hand are formed.

The step in the aforementioned method of modifying the intermediate award to provide a final award if the dealer's final hand satisfies one or more second predefined criteria, wherein the relationship between the final award and the intermediate award is determined by one or more mathematical formulas associated with at least the second satisfied predefined criteria, may further include multiplying the intermediate award if the cumulative numerical value of the dealer's final hand is greater than twenty-one and multiplying the additional award by two.

The card game in the aforementioned methods is preferably blackjack, baccarat or a poker-type game.

The present invention is also directed to a method of playing a wagering card game comprising an underlying card game comprising blackjack and an auxiliary card game including the steps of placing at least one wager on the underlying blackjack game; placing a wager on the auxiliary card game; dealing two cards to a player in the blackjack game; and dealing two cards to a dealer hand; displaying the player's cards to determine if the auxiliary card game has been won according to the rules of the auxiliary game. According to this method of the present invention, if the two cards dealt to the player wins an amount in the auxiliary card game and the dealer's hand satisfies a predefined event, the amount the player wins in the auxiliary card game is changed.

The predefined event can be the dealer busting, a suited event in the dealer's hand, or a suited blackjack in the dealer's hand. The amount won in the auxiliary card game can be increased by the predefined event being achieved. The increase can be the addition of an absolute amount. The auxiliary card game may be a bonus event.

The present invention is also directed to a machine readable media for facilitating a method of playing a game having an award modifying feature. The media includes a data segment for: storing game data relating to a card game in which players play against a dealer having a predefined intermediate condition and a final outcome; storing wagering data relating to a monetary amount wagered on a card game involving a player playing against a dealer in an wagering database; storing intermediate condition data relating to an intermediate predefined criteria and a mathematical formula for calculating the appropriate intermediate award; and storing final outcome data relating to a final predefined criteria and a mathematical formula for calculating the appropriate modification to the intermediate award.

The media according to the present invention also includes a code segment for: playing the card game until the predefined intermediate condition is reached; determining if an intermediate award is appropriate based on whether a predefined intermediate criteria is satisfied; playing the card game until the final outcome is reached; determining if the intermediate award should be modified based on whether a final predefined criteria is satisfied at the final outcome; and modifying the intermediate award based on the determination.

The present invention is also directed to a multi-player platform that provides multiple player positions for live players to engage in a blackjack game having an award modifying feature with a virtual dealer and virtual cards comprising at least two player positions that enable live players to place wagers on the game, a display system for showing a virtual dealer, a display system for showing the virtual cards used in play of the game, and a database that contains the rules of the game, the processor enabling play for each player on the blackjack game according to the rules in the database.

The game associated with the multi-player platform of the present invention includes the steps of wagering a monetary amount; playing the card game until an intermediate condition is reached, wherein the intermediate condition includes providing a player and the dealer with one or more cards to form a player's intermediate hand and a dealer's intermediate hand, respectively; providing an intermediate award to a player if the player's intermediate hand satisfies one or more first predefined criteria, wherein the intermediate award is determined by a predetermined set of rules stored in the database; playing the card game until a final outcome is reached, wherein upon reaching the final outcome the player forms a player's final hand and the dealer forms a dealer's final hand; and modifying the intermediate award to provide a final award if the dealer's final hand satisfies one or more second predefined criteria stored in the database, wherein the relationship between the final award and the intermediate award is determined by one or more mathematical formulas stored in the database and associated with at least the second satisfied predefined criteria. The aforementioned platform may include other games and methods in accordance with the present invention.

The present invention is also directed to a system for playing a game having an award modifying feature. The system includes a database for storing game data relating to the rules of a card game, a first predefined criteria including a first predetermined set of rule relating to an intermediate award payment amount, a second predefined criteria including a mathematical formula for determining an award modification; a processor for playing the card game until an intermediate condition is reached, wherein the intermediate condition includes providing the player and the dealer with one or more cards to form a player's intermediate hand and a dealer's intermediate hand, respectively; determining if the first predefined criteria is satisfied; determining the intermediate award based on the predetermined set of rules if the first predefined criteria is satisfied; playing the card game until a final outcome is reached, wherein upon reaching the final outcome the player forms a player's final hand and the dealer forms a dealer's final hand; determining if the second predefined criteria is satisfied; calculating the modification to the intermediate award using the mathematical formula if the second predefined criteria; a user interface configured for receiving wagers from the players, communicating the game play to the players and distributing the award to players.

The user interface in a system of the present invention may be configured to operate over the world wide web, thus permitting players to play the card game using the world wide web.

These and other aspects of the system and method of the present invention will become more readily apparent to those having ordinary skill in the art from the following detailed description of the invention taken in conjunction with the drawings.

### BRIEF DESCRIPTION OF THE FIGURES

So that those having ordinary skill in the art to which the present invention pertains will more readily understand how to make and use the method and system of the present disclosure, embodiments thereof will be described in detail herein below with reference to the drawings, wherein:

FIG. 1 shows a top plan view of a prior art format for an automated gaming system;

FIG. 2 shows a top plan view of a prior art format for an automated gaming system;

FIG. 3 shows a side elevational view of a prior art format for an automated gaming system;

FIG. 4 shows a block schematic diagram of the electronic configuration of a prior art automated gaming system;

FIG. 5 shows a perspective view of a format for an automated gaming system according to the present invention;

FIG. 6 shows a schematic diagram of a gaming engine useful in the practice of the present invention;

FIG. 7 shows a schematic diagram of a player station useful in the practice of the present invention; and

FIG. 8 shows a schematic diagram of a game display useful in the practice of the present invention.

### DETAILED DESCRIPTION OF THE INVENTION

The following description illustrates various exemplary and preferred embodiments of the game of the present invention, but is not intended to limit the scope thereof. The present invention is directed to a system and method for providing an auxiliary game to the game of blackjack which can be played by one or more players and is configured or adapted to provide an award (also referred to herein as a “bonus award”) at one or more intermediate stages of the game prior to determining the ultimate outcome of the primary blackjack game (also referred to herein as “bonus events”).

The intermediate award of the present invention is determinable based on a comparison of facts, such as card values, as they exist while the game is in an intermediate condition, with predefined criteria, such as cards of a particular value or rank. This aspect of the present invention is also generally referred to hereinafter as the “intermediate” or “bonus” action.

The facts to be compared with the predefined winning criteria are preferably related to the game status of the players or dealer, if any. For example, in some of the card games discussed herein, the facts used for comparison against the predefined criteria relate to the particulars of a player's initial cards.

The selection of an intermediate stage in which to make the award determination may vary based on the game being played, among other things. It is preferable that the game of the present invention be of a kind which includes multiple steps in the play of the game that facilitates a break in the action to conduct the criteria comparison. For example, in a preferred embodiment discussed further herein, the game involves a card game played according to the rules of blackjack. As discussed above, blackjack involves a first round of card dealing in which a player's hand is formed with two displayed player cards and a dealer's hand is formed with one displayed card and one hidden dealer card. This stage of the card game provides an advantageous opportunity in which to conduct a comparison check in accordance with the present invention. If the predefined criteria are satisfied, an intermediate award can be paid while the game is in this unfinished or intermediate condition prior to the final outcome of the game. In this example, the criteria for comparison can be related to the occurrence of particular cards within the group of displayed cards, either the player's, the dealer's or a combination of both.

In the preferred embodiment wherein the card game being played is blackjack, the criteria for determining whether an intermediate award should be paid is preferably based on the player's hand being blackjack (i.e., a two card hand in which one card is an “Ace” and the other card has a numerical value of ten) after the initial deal. It should be readily apparent to those skilled in the art the criteria can be predefined to be other hands, such as any pairs or cards of the same suit, among others.

If the predefined criteria are not satisfied in the intermediate condition, the final outcome of the game may still result in a monetary award for the player that wins the game in accordance with the rules of that game. The intermediate award is provided in addition to any other payout that may be appropriate, such as in the case of the player's hand being blackjack, or the award given when the player wins upon final outcome of the game. Preferably, the intermediate award requires satisfying further criteria beyond what is normally payable, such as a blackjack with cards having the same suit, a certain card ranking or a particular two suits, among others. The intermediate award can be based on a preset mathematical formula or odds payouts, such as a paytable, which determines the amount to be paid in relation to the original wager. Preferably, the payout odds provides for varying awards depending on the particular cards forming the player's hand.

The present invention provides for an award modifying feature in which the outcome of the underlying card game, (i.e., the underlying game being played independently of the intermediate action, related predefined criteria for comparison, and stage or point of resolution thereof) will have an effect on the intermediate award should the predefined criteria be satisfied in the intermediate stage. Preferably, the intermediate award is modified based on the occurrence of a second predefined event. In accordance with the present invention, if the second criteria for this event are satisfied upon the final outcome of the game, the intermediate award is modified. Preferably, the intermediate award is modified based on a preset formula. In the preferred embodiment, a multiplier is applied to the intermediate award, such as 2×, such that the intermediate award is doubled when the predefined event is a dealer bust.

The card game of the present invention can be played (either live, direct electronically, at a player station or on the internet) with wagers being placed on the final outcome of the game, the dealer hand or a bonus hand in the intermediate stage. In addition to the wagering on the underlying game, there can be a side bet available. The side bet may be optional or mandatory. Independent of the events in winning the underlying game and winning the side bet, activity or events in the dealer's hand or bonus hand can modify the size of the bonus paid when the bonus is won.

The game of the present invention can be in the form of an executable program played on a computerized apparatus or system which may be integrated with one or more multimedia transceiving terminals. It should be readily apparent to those skilled in the art that a system in accordance with the present invention can include various computer and network related software and hardware, such as computer language programs, operating systems, memory storage devices, input/output devices, data processors, servers with links to data communication systems, wireless or otherwise, such as those which take the form of a local or wide area distributed computing network, and a plurality of data transceiving terminals within the network, such as personal computers or otherwise. It should be understood that the system of the present invention may also include multiple, redundant or backup devices of those described herein. Those skilled in the art will further appreciate that, so long as its users are provided with access to a system and the ability to play the game according to the present invention, the type of network, software or hardware is not vital to its full implementation.

In an exemplary embodiment, the core functional components of a game system of the present invention include a database, processor, and one or more graphical user interfaces. The exemplary system can be configured to function as a free standing terminal but may also be configured provide the game of the present invention to a plurality of players via the world wide web.

The system provides game play to players through graphical user interfaces which preferably include data entry terminals and monitors that provide visual depictions of the game as play ensues. The data entry terminals are preferably adjacent the monitor and can include buttons, touch screens, voice responsive actuators or any other device for indicating a preference.

The data storage device contains the programming, game rules, predefined criteria, wagering and awarding information in accordance with the present invention, which is operatively associated with one or more analytical processors by a control program. Programs in the system of the present invention may contain an instruction set written in a conventional computing language such as HTML, C++ or Java, for coordinating the interactive relationship between the data storage device, processor and graphical user interface.

The game play on the system of the present invention is initiated by the player placing a wager. The wager can be placed by the player inserting money into a specially configured receiving slot in the data terminal or electronically from a credit card inserted into a credit card reader. The wager amount is temporarily stored in the data storage device. The system accesses the game rules from the data storage device and game play continues until the intermediate condition of the game is reached.

At this point, the system compares the existing circumstances in the game with the predefined criteria set in storage to determine if any such criteria are satisfied. Once this information is processed, the system determines the amount of the intermediate award based on mathematical formulas in the data storage device. If the criteria is not satisfied the intermediate award is zero.

Upon completion of this process, the game play continues until the final outcome is reached. The system processes this event and determines if a payout is appropriate based on the rules of the game. The system also accesses the second predefined criteria associated with the final outcome of the game to compare this criteria with the existing conditions at the final outcome. If the criteria are satisfied, the system determines the appropriate modification to the intermediate award. If the intermediate award was zero, the modification is also zero at the final outcome. At this point the system restarts and a new game according to the present invention begins as described above.

Games according to the present invention may be implemented as live table games, television or cable game show game, video poker gaming machine platforms, hand-held games for play, multiple player interactive wagering platform games (with kiosk formats, single player screens, community screens, and/or banks of seats for players with a common dealer screen), cell phone games, games downloadable from the internet, parlor games, games executed on personal computers, palm pilots, play stations and the like. Each of the above game formats, among others, is contemplated by the present invention. Examples of known multiple player platforms are described in U.S. Pat. No. 6,607,443 and in U.S. application Ser. No. 10/764,827, filed Jan. 26, 2004 and published as U.S. Publication No. 2005/0164759. The content of these two disclosures are hereby incorporated herein by reference in their entireties.

In accordance with another embodiment, the game of the present invention is provided in a multi-player system configured to simulate a live table game as described herein below. The system of the present invention is adapted to provide interactive game play, including receiving real-time wagers from one or more live game players and presenting representative game hands without involving physical playing cards or live casino personnel such as dealers. Systems of the present invention, such as a multi-player platform, can be constructed, modified, or retrofitted in accordance with the present invention.

A multi-player gaming system that can be used to practice the method of the present invention comprises a table and a dealer “virtual” video display system positioned for view by players seated at the table. The table may seat at least two players up to the amount of players that can be configured about the table and have a view of the dealer video display system. Typically each gaming system will have at least four player available positions, with space determinations considered as to whether there would be 4, 5, 6 or 7 player positions. It is possible to have a completely circular dealer display (e.g., holographic display in a cylindrical centerpiece) and have players distributed around the entire periphery, but this is too dissimilar to standard play arrangements and could slow the game down, as play should approximate that of a live game, with players playing in sequence. A surface of the table will include a display surface for showing all player hands, community cards, dealer hands and any other cards used to play the game for any purpose, and, chips or other wagering designations. The table surface may include push button and or touch screen player controls, with our without other display features specific to the individual player. For example, the individual player screen may show a running history of wins/losses, credits available, credits bet and play options. A majority of the table surface comprises a video monitor in one example of the invention. Where there are no touch screen controls, the table surface may include player control panels at each player station near the continuous display surface.

The use of a large or continuous display surface offers some significant advantages in simulating or recreating a standard card table surface. Cards may be readily viewed by other players at a table, which is standard in table games and adds to player enjoyment. Individual monitors, especially where slanted towards the individual players make such table-wide card reading difficult. The use of the full screen (continuous) display also allows for better animation to be provided, such as displaying virtual images of cards moving to the player and “virtual” chips being placed on the table when wagers are indicated. For purposes of this disclosure, the term “virtual” means a graphical video representation of a real object or person, such as a dealer, cards and chips, for example.

The individual player positions preferably have a separate intelligence at each player position that accepts player input and communicates directly with a game engine (main game computer or processor). The intelligence is preferably an intelligent board that can process information. For purposes of this disclosure the term “intelligent” refers to the ability to execute code, either provided in the form of software or hardware or a combination of software and hardware circuits. Such processing may at least comprise some of signal converting (e.g., signals from player card readers, credit deposit, currency readers, coin readers, touch screen signals, ticket readers/printers and control panel signals) into a signal that can be included in an information packet and interpreted by the main game computer when the signal is sent. Communication between the intelligence at each player position is direct to the main game computer and may be by self-initiated signal sending, sequenced polling by the main game computer (e.g., each position communicates directly to the main game computer in turn), timed communication, or any other order of communication that is direct between the intelligence and the main game computer.

One preferred form of communication between the main game computer and player station computers is by means of self-initiated signal sending. There is essentially a single main game computer that contains video display controls and programs for both the dealer display and the table top display, audio controls and programs, game rules (including storage of multiple games if intended to be available on the machine), random number generator, graphic images, game sequence controls, security systems, wager accounting programs, external signaling and audit functions, and the like. In other forms of the invention, the above functions are divided between a main processor and one or more additional processors. The intelligence at each player position speeds up the performance of all aspects of the game by being able to communicate directly with the main game computer and being able to process information at the player position rather than merely forwarding the information in raw form to the main game computer. Processing player information at player positions frees up resources for use by the main processor or processors.

A card game system may also include a suitable data and control processing subsystem that is largely contained within a main control module supported beneath the tabletop. The control and data processing subsystem includes a suitable power supply for converting alternating current from the power main as controlled by a main power switch. The power supply transforms the alternating line current to a suitable voltage and to a direct current supply. Power is supplied to a power distribution and sensor/activity electronics control circuit. Commercially available power switching and control circuits may be provided in the form of a circuit board which is detachable, and plugs into a board receptacle of a computer mother board or an expansion slot board receptacle. A main game controller motherboard may include a central microprocessor and related components well-known in the industry as computers using Intel brand Pentium® microprocessors and related memory or intelligence from any other manufacturing source. A variety of different configurations and types of memory devices can be connected to the motherboard as is well known in the art. Of particular interest is the inclusion of two flat panel video display control boards connected in expansion slots of the motherboard. Display control boards are each capable of controlling the images displayed for the dealer video display and for the common display area. More specifically, the display control boards are connected to player bet interface circuits for the player stations. This arrangement allows the display control boards to provide necessary image display data to the display electronic drive circuits associated with the dealing event program displays and the dealer display.

The motherboard and/or the individual player intelligent boards also include a serial port that allows stored data to be downloaded from the motherboard to a central casino computer or other additional storage device. In one example, each player board communicates directly with the casino computer system. This allows card game action data to be analyzed in various ways using added detail, or by providing integration with data from multiple tables so that cheating schemes can be identified and eliminated, and player tracking can be maintained. Player performance and/or skill can be tracked at one table or as a compilation from gaming at multiple tables, as by using Bloodhound™ security software marketed by Shuffle Master, Inc., which may be incorporated into this automated gaming system. Additionally, player hand analysis can be performed. The motherboard and/or individual player intelligent boards may also have a keyboard connection port that can be used to connect a larger format keyboard to the system to facilitate programming and servicing of the system.

Although the preferred system shown does not require features illustrated for receiving automated player identification information, such features can alternatively be provided. Card readers such as used with credit cards, player cards or other identification code reading devices can be added in the system to allow or require player identification in connection with play of the card game and associated recording of game action by one of the processors. Such a user identification interface, for example a card reader located at each player station, can be implemented in the form of a variety of magnetic card readers commercially available for reading user-specific identification information. The user-specific information can be provided on specially constructed magnetic cards issued by a casino, or magnetically coded credit cards or debit cards frequently used with national credit organizations such as VISA, MASTERCARD, AMERICAN EXPRESS, casino player card registry, banks and other institutions. The information could also be provided on other writable media, such as an RFID chip or card with writable memory, or bar coding, as just a few examples.

Alternatively, it is possible to use so-called smart cards to provide added processing or data storage functions in addition to mere identification data. For example, the user identification could include coding for available credit amounts purchased from a casino. As further example, the identification card or other user-specific instrument may include specially coded data indicating security information such as would allow accessing or identifying stored security information which must be confirmed by the user after scanning the user identification card through a card reader. Such security information might include such things as file access numbers which allow the central processor to access a stored security clearance code which the user must indicate using input options provided on displays using touch screen displays. A still further possibility is to have participant identification using a fingerprint image, eye blood vessel image reader, or other suitable biological information to confirm identity of the user that can be built into the table. Still further it is possible to provide such participant identification information by having the pit personnel manually code in the information in response to the player indicating his or her code name or real name. Such additional identification could also be used to confirm credit use of a smart card or transponder. All or part of the functions dedicated to a particular player station are controlled by the player station intelligence in one form of the invention. Additionally, each player station intelligence may be in communication with a casino accounting system.

It should also be understood that the player display screens can alternatively be provided with suitable display cowlings or covers that can be used to shield display of card images from viewing by anyone other than the player in games where that is desirable. This shielding can also be effected by having light-orientation elements in the panel, and some of these light-orientation elements are electronically controllable. This type of shielding could also be used in controlling visual access to the main game play screen. In this manner, the processor can allow general viewing of cards in games where that is desirable or tolerated, and then alter the screen where desired. These types of features can be provided by nanometer, micrometer or other small particulate or flake elements within a panel on the viewing area that are reoriented by signals from the processor. Alternatively, liquid crystal or photo chromatic displays can be used to create a screening effect that would allow only viewers at specific angles of view from the screen area to view the images of cards. Such an alternative construction may be desired in systems designed for card games different from blackjack, where some or all of the player or dealer cards are not presented for viewing by other participants or onlookers. Such display covers or cowlings can be in various shapes and configurations as needed to prevent viewing access. It may alternatively be acceptable to use a player-controlled switch that allows the display to be momentarily viewed and then turned off. The display can be shielded using a cover or merely by using the player's hands. Still further it is possible to use a touch screen display that would be controlled by touch to turn on and turn off. Similar shielding can be used to prevent others from viewing the display.

A review of the Figures will assist in a further understanding of the invention.

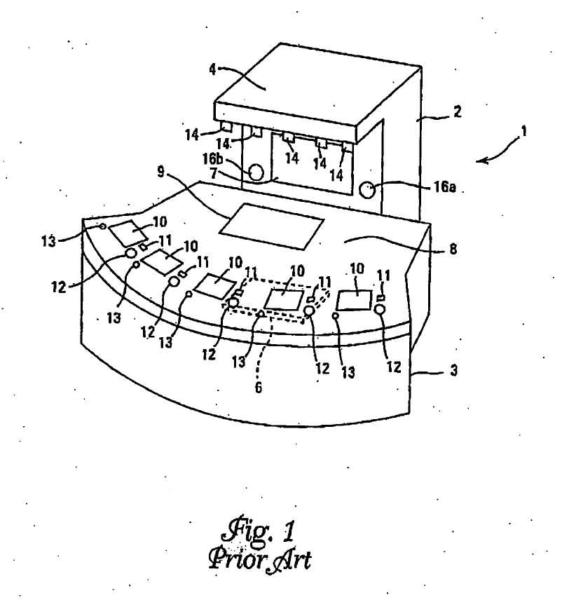

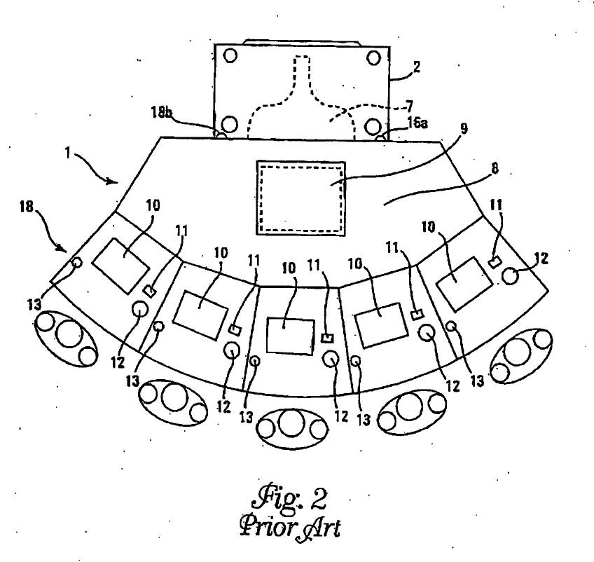

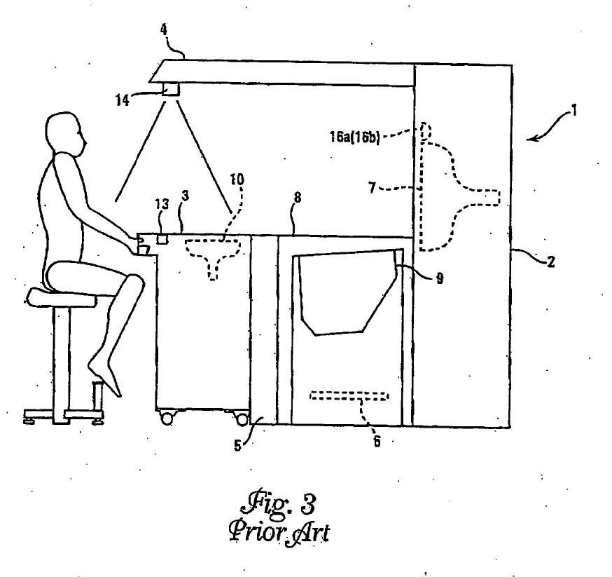

FIG. 1 shows a fully automated gaming table 1 of the prior art, as disclosed in U.S. patent application 2003/0199316. The system 1 comprises a vertical upright display cabinet 2 and a player bank or station cluster arrangement 3. The vertical display cabinet 2 has a viewing screen 7 on which images of the virtual dealer are displayed. The top 8 of the player bank arrangement 3 has individual monitor screens 10 for each player position, as well and tabletop inserted coin acceptors 11, and player controls 12 and 13. There is a separate and larger game play screen 9 on which dealer and player cards are displayed in a format large enough for all players to view. Additionally, wager areas and/or virtual chips representing wagers are also displayed in this area. Speakers 16a and 16b are provided for sound transmission and decorative lights 14 are provided. FIG. 2 shows a top plan view of the same prior art automated gaming system 1 with the viewing screen 7 shown more clearly as a CRT monitor. It can also be seen that each player position has to form an arc cut into the semicircular player seating area 18. FIG. 3 shows a side elevational view of the same prior art automated gaming system of FIGS. 1 and 2 where the orientation of the three different types of CRT monitors 7, 9 and 10 are shown.

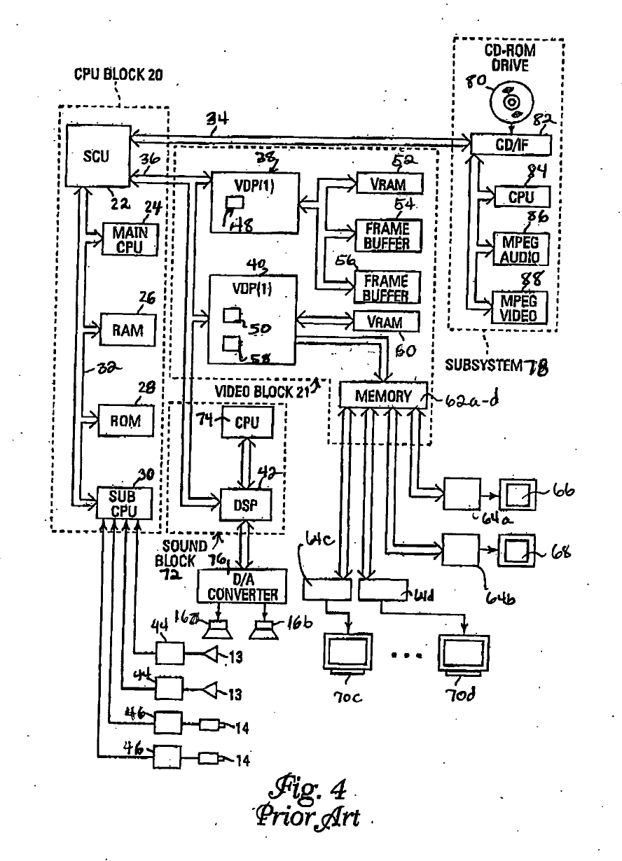

FIG. 4 shows the schematic circuitry of a prior art automated system as disclosed in 2003/0199316. FIG. 4 is a block diagram of processing circuitry in the game device of FIG. 1. The game device housing comprises a CPU block 20 for controlling the whole device, a picture block 21 for controlling the game screen display, a sound block for producing effect sounds and the like, and a subsystem for reading out CD-ROM.

The CPU block 20 comprises an SCU (System Control Unit) 22, a main CPU 24, RAM 26, RAM 28, a sub-CPU 30, and a CPU bus 32. The main CPU 24 contains a math function similar to a DSP (Digital Signal Processing) so that application software can be executed rapidly.

The RAM 26 is used as the work area for the main CPU 24. The RAM 28 stores the initialization program used for the initialization process. The SCU 22 controls the busses 32, 34 and 36 so that data can be exchanged smoothly among the VDPs 38 and 40, the DSP 42, and other components.

The SCU 22 contains a DMA controller, allowing data (polygon data) for character(s) in the game to be transferred to the VRAM in the video picture block 21. This allows the game machine or other application software to be executed rapidly. The sub-CPU 30 is termed an SMPC (System Manager & Peripheral Control). Its functions include collecting sound recognition signals from the sound recognition circuit 44 or image recognition signals from the image recognition circuit 46 in response to requests from the main CPU 24. On the basis of sound recognition signals or image recognition signals provided by the sub-CPU 30, the main CPU 24 controls changes in the expression of the character(s) appearing on the game screen, or performs image control pertaining to game development, for example. The picture video block 21 comprises a first VPD (Video Display Processor) 38 for rendering TV game polygon data characters and polygon screens overlaid on the background image, and a second VDP 40 for rendering scrolling background screens, performing image synthesis of polygon image data and scrolling image data based on priority (image priority order), performing clipping, and the like. The first VPD 38 houses a system register 48, and is connected to the VRAM (DRAM) 52 and to two frame buffers 54 and 56. Data for rendering the polygons used to represent TV game characters and the like is sent to the first VPD 38 through the main CPU 24, and the rendering data written to the VRAM 52 is rendered in the form of 16- or 8-bit pixels to the rendering frame buffer 54 (or 56). The data in the rendered frame buffer 54 (or 56) is sent to the second VDP 40 during the display mode. In this way, buffers 54 and 56 are used as frame buffers, providing a double buffer design for switching between rendering and display for each individual frame. Regarding information for controlling rendering, the first VPD 38 controls rendering and display in accordance with the instructions established in the system register 48 of the first VPD 38 by the main CPU 24 via the SCU 22.

The second VDP 40 houses a register 50 and color RAM 58, and is connected to the VRAM 60. The second VDP 40 is connected via the bus 36 to the first VPD 38 and the SCU 22 and is connected to picture output terminals Voa through Vog through memories 62a-d and encoders 64a-d. The picture output terminals Voa through Vog are connected through cables to the main game displays 66, 68 and the satellite displays 70. Scrolling screen data for the second VDP 40 is defined in the VRAM 60 and the color RAM 58 by the CPU 24 through the SCU 22. Information for-controlling image display is similarly defined in the second VDP 40. Data defined in the VRAM 60 is read out in accordance with the contents established in the register 50 by the second VDP 40, and serves as image data for the scrolling screens that portray the background for the character(s). Image data for each scrolling screen and image data of texture-mapped polygon data sent from the first VPD 38 is assigned display priority (priority) in accordance with the settings in the register 48, and the final image screen data is synthesized.

Where the display image data is in palette format, the second VDP 40 reads out the color data defined in the color RAM 58 in accordance with the values thereof, and produces the display color data. Color data is produced for each display 66 and 68 and for each satellite display 70. Where display image data is in RGB format, the display image data is used as-is as display color data. The display color data is temporarily stored in memories 62a-d and is then output to the encoders 64a-d. The encoders 64a-d produce picture signals by adding synchronizing signals to the image data, which is then sent via the picture output terminals Voa through Vog to the display 66, 68 and the satellite displays 70. In this way, the images required to conduct an interactive game are displayed on the screens of the display 66, 68 and the satellite displays 70.

The sound block 72 comprises a DSP 42 for performing sound synthesis using PCM format or FM format, and a CPU 74 for controlling the DSP 42. Sound data generated by the DSP 42 is converted into 2-channel sound signals by a D/A converter 76 and is then presented to audio output terminals Ao via an interface (not shown). These audio output terminals Ao are connected to the input terminals of an audio amplification circuit (not shown). Thus, the sound signals presented to the audio output terminals Ao are input to the audio amplification circuit (not shown). Sound signals amplified by the audio amplification circuit drive the speakers 16a and 16b.

The subsystem 78 comprises a CD-ROM drive 80, a CD-I/F 82, and CPU 84, an MPEG-AUDIO section 86, and an MPEG-PICTURE section 88. The subsystem 78 has the function of reading application software provided in the form of a CD-ROM and reproducing the animation. The CD-ROM drive 80 reads out data from CD-ROM. The CPU 84 controls the CD-ROM drive 80 and performs error correction on the data read out by it. Data read from the CD-ROM is sent via the CD-I/F 82, bus 34, and SCU 22 to the main CPU 24 that uses it as the application software. The MPEG-AUDIO section 86 and the MPEG-VIDEO section 88 are used to expand data that has been compressed in MPEG (Motion Picture Expert Group) format. By using the MPEG-AUDIO section 86 and the MPEG-VIDEO section 88 to expand data that has been compressed in MPEG format, it is possible to reproduce motion picture. It should be noted herein that there are distinct processor for the CPU block, video block, sound block, CD-ROM drive and Memory with their independent CPU's. This requires significant computing power and still has dumb (no intelligence) player input components.

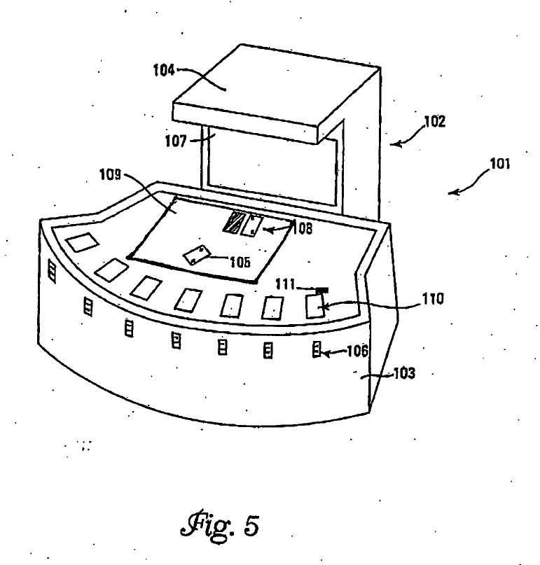

FIG. 5 shows another example of an automated table system 101 useful to practice the game play methods of the present invention. The system 101 has an upright dealer display cabinet 102 with a top 104 and the dealer viewing screen 107 which may be any form of display screen such as a CRT, plasma screen, liquid crystal screen, LED screen or the like. The dealer screen 107 displays a virtual dealer, the dealer responding to instructions from the players. The player bank arrangement 103 has a continuous display screen 109 on which images of cards being dealt 105, dealer's cards 108, player cards, 105, bets wagered (not shown) and also includes touch screen and/or electromechanical player input functions 110. The display 110 at each player station can also display information such as the composition of the player's hand, the credits wagered, historical win/loss information, pay tables and the like. Other player input functions may be provided on a panel 106 which might accept currency, coins, tokens, identification cards, player tracking cards, ticket in/ticket out acceptance, and the like.

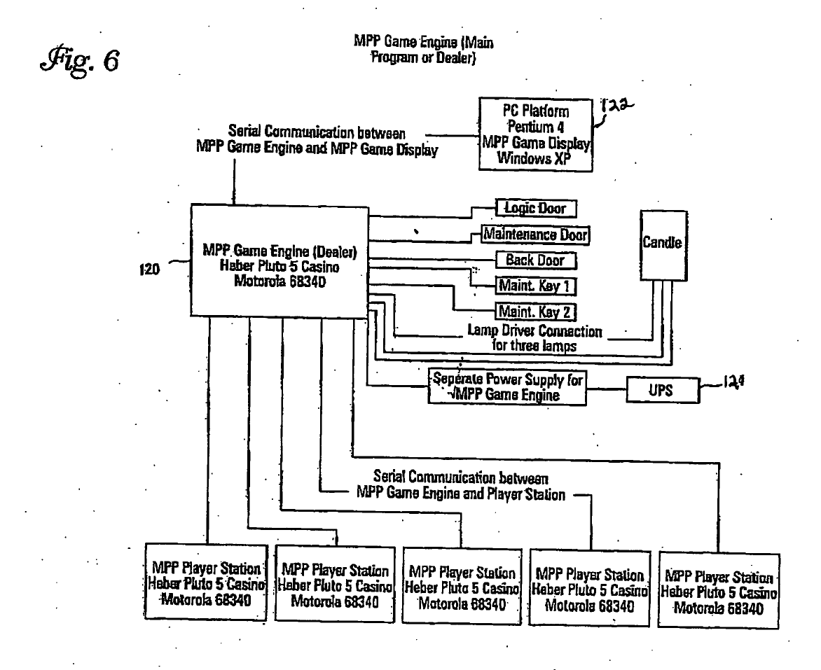

FIG. 6 shows an electronic/processor schematic for a MultiPlayer Platform (MPP) gaming system according to the presently described. The MPP Game engine (dealer) comprises a Heber Pluto 5 casino game board 120 (Motorola 68340 board) operating off the PC Platform Pentium® 4 MPP Game Display processor 122. The game display processor operates on a Windows XP platform. The respective subcomponents on the Pentium 4 processor are labeled to show the apportionment of activity on the motherboard and the component parts added to the board. As is shown, the game engine has an Uninterruptible Power Supply 124. The game display processor directs activity on the Speakers, directs activities onto the MPP Game Service panel, and the Plasma Monitor Card Table display. It is important to note that all communications are direct from the game display processor, freeing up resources available to the game engine processor.

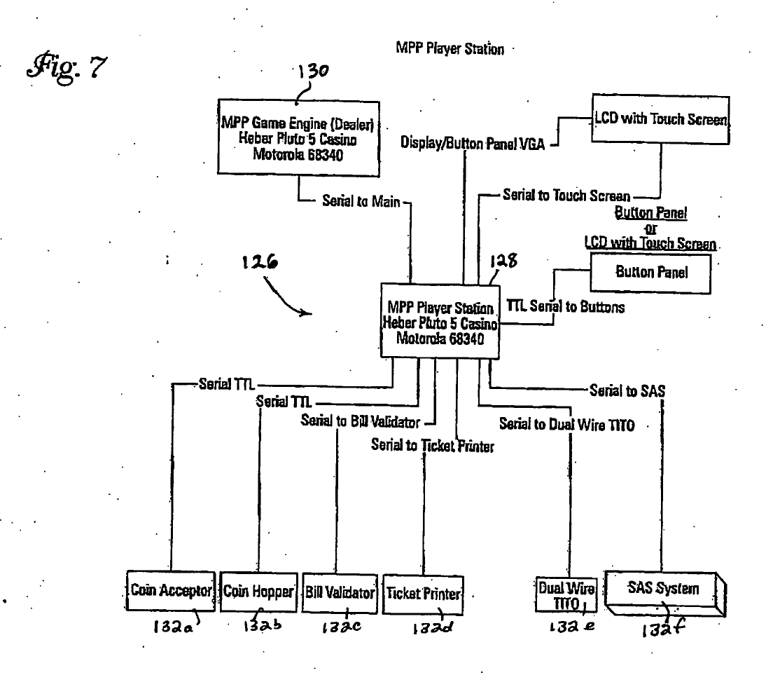

FIG. 7 shows the electronic/processing schematics 126 of the MPP Player Station Intelligence board 128 (Heber Pluto 5 Casino, Motorola 68340), each of which player stations (one for each player position) is in direct connection to the MPP Game Engine 130 (Dealer), which is in turn directly connected to the PC Platform. (not shown in this Figure). Each Intelligence board receives information for all player input systems 132a-f specific to that player station, such as the shown Coin Acceptor, Coin Hopper, Bill validator, Ticket Printer, Touch Screen and/or Display Button Panel, Dual Wire Ticket-in-Ticket-Out Printing and SAS System (SAS is one exemplary standard communications protocol used by a number of casinos central computer systems.) A significant benefit resides in the use of the independent Intelligence boards 128 at each player position being in direct communication with the MPP Game Engine 130, as opposed to each individual player position button panel being dead or inactive until authorized by the main game processor, as previous automated gaming systems were constructed.

The above-described architecture is also an improvement in providing a system with not only the intelligence at each player position, but also in redistributing processing capability for functions among various processing components within the gaming system. In one architectural format, all functions of the gaming engine, except for the player localized intelligence functions, are consolidated into a single PC (e.g., the Pentium 4 shown in the Figures). This would include all game functions, player video functions, dealer video functions, dealer audio functions, security, central reporting (to a casino's central computer, for example), currency and debit functions, alarm functions, lighting functions, and all other peripherals on the system, except for the localized player functions. Alternatively, all functions requiring communication with the casino's main computer system are located on the player station intelligent boards. In this system, the main game processor would talk directly with the player intelligent boards, preferably in the same novel communication format described below.

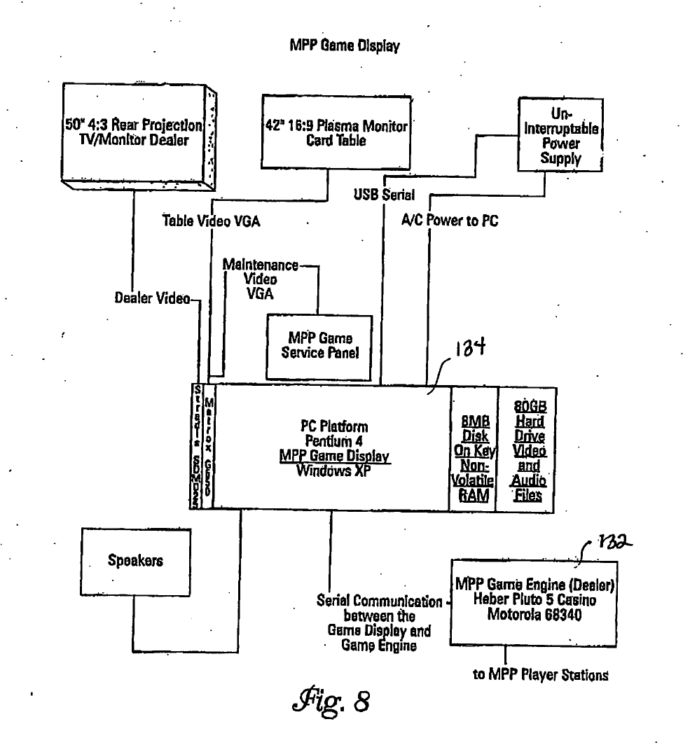

An alternative system is shown in FIG. 8, where there is a dealer engine processor 132 intermediate the main game PC 134 and the Player intelligent boards (not shown). Both systems are a distinct improvement over the prior art, but with the higher power available for PC's, and with the ease of programming a PC as opposed to an embedded system, the consolidation of the game functions and the ability of the main game engine to communicate with each of the player positions is enabled. As shown in FIG. 8, the Game display processor 134 is preferably a Pentium® 4 PC and is separate from the main processor 132. With the player intelligent boards, the main game PC can receive packets of information from each player station as events occur rather than having to poll each player position on a regular basis 100 times to gain the specific information for each player input that may be made.

A description of the Heber Board, (an exemplary board that can be used as a player station processor and/or game engine processor 132) a commercially available intelligent processing board is as follows. The Heber Board is known for its reliability and flexibility, especially for the Pluto 5 family of gaming products. The Pluto 5 is the controller of choice for the global gaming industry. Flexibility comes from a set of features built into the Pluto 5 (Casino) controller, and from the choice of optional add-on boards that can be used to adapt the Pluto family to best suit individual applications. In the area of interfacing, there are three distinct boards, each of which serves a particular function in helping the Pluto 5 to connect with the world outside:

RS485 Board

RS485 is an industrial-grade board for linking multiple systems in unforgiving circumstances for centralized information gathering. The Heber RS485 board is fully optically-isolated to provide complete circuit safety when used within ‘electrically noisy’ environments. The RS485 board uses a single RS232 connection to the Pluto 5 board and all necessary power is also derived through this link. Two header connectors may be provided for the RS485 channel to allow daisy chain connections between multiple systems.

HII/ccTalk Board

This board specializes in communicating with industry standard note/coin acceptors and payout hoppers. Equipped with dual communication channels, each port is configurable to use either the HII format to connect with Mars® coin/note acceptors or the ccTalk format for Money Controls® hoppers. Both channels are controlled via a single RS232 connection to the Pluto 5 board and all necessary power is also derived through this link. The Heber FastTrack™ package contains modular library functions for passing information via these channels.

Four Channel Relay Board

The relay board allows control of medium- to high-level loads such as solenoids, without risk of damage or interference to the Pluto 5 circuitry. Four power-switching channels are available with absolute isolation from the Pluto 5 control signals. Each relay is capable of switching direct or alternating currents of up to 7 A at a maximum voltage of 250V.

Like the Pluto 5 board itself, its modular options have been used extensively so that their designs are fully developed and entirely stable. The options that are specified are consistently provided in mass quantities. As with all Pluto products, programming for the modular options is straightforward. This is enhanced with the use of the Pluto 5 Enhanced Development Kit and also the FastTrack™ package. Between them, these kits contain all of the low level and high level programming tools and library functions needed for gaming applications. These systems can be provided through a Pluto 5 Enhanced Development Kit datasheet 80-15353-7 (Heber Limited, Belvedere Mill, Chalford, Stroud, Gloucestershire, GL6 8NT, UK Tel: +44 (0) 1453 886000 Fax: +44 (0) 1453 885013; www.heber.co.uk). Specifications for the various boards are identified below.

RS485 Interface

Host Interface

RS232 connection to Pluto 5/Pluto 5 Casino
All power provided via RS232 link from host system
   Communication Port
Dual four-way Molex 0.1″ KK headers for daisy chaining purposes
   Dimensions
80×61 mm (3.14×2.4″)
   Part Number
Opto-isolated RS485 board
01-14536-2
   HII/ccTalk Interface
   Host Interface
RS232 connection to Pluto 5/Pluto 5 Casino
All power provided via RS232 link from host system
   Communication Port
Single or dual 10 way header connectors
   Dimensions
101.6×69.85 mm (4×2.8″)
   Part Number
Dual channel HII/ccTalk board
01-16171-2
   Four Channel Relay Board
   Host Interface
Connection to Pluto 5/Pluto 5 Casino via ribbon cable using four standard output lines
All power provided via ribbon cable link from host system
   Switching Capabilities
Up to 250V AC or DC @ 7 A maximum per channel
   Dimensions
80×61 mm (3.14×2.4″)
   Part Number
Four channel relay board
01-15275-1
80-16949-1

One proposed hardware configuration uses a “satellite” intelligent processor at each player position. The player station satellite processor is substantially the same as the primary game engine processor, a Heber Pluto 5 Casino board. The satellite processors receive instruction from the primary game engine but then handle the communications with player station peripherals independently. Each satellite processor communicates with only the peripherals at the same player station. Thus each player station has a dedicated satellite processor communicating with only the peripherals at the same player station and with the casino's central computer system. The peripherals are, but not limited to: Slot accounting Systems, Bill Validator, Ticket Printer, Coin Acceptor, Coin Hopper, Meters, Button panel or LCD touch screen and various doors and keys.

The satellite processors run proprietary software to enable functionality. The player station software is comprised of two modules, the first being an OS similar to the game engine Operating System and the second being station software that handles peripheral communications. The software may be installed on EPROMs for each satellite processor. The primary method of communication between the satellite processors and the primary game engine is via serial connectivity and the previously described protocol. In one example, information packets are prepared by the satellite processors and are sent to the game engine processor on the happening of an event.

The proposed game engine provides communication to the player stations to set the game state, activate buttons and receive button and meter information for each player station. Communication is via a serial connection to each of the stations. The new protocol for communication between the game engine, game display and player stations is an event driven packet-for-packet bi-directional protocol with Cyclic Redundancy Check (CRC) verification. This is distinguished from the Sega system that used continuous polling. This communication method frees up resources in the same engine processor because the processor no longer needs to poll the satellites continuously or periodically.

The new protocol uses embedded acknowledgement and sequence checking. The packet-for-packet protocol uses a Command Packet, Response Packet and a Synchronization Packet as illustrated below. The protocol uses standard ASCII characters to send data and a proprietary verification method.

Format of Command Packet

| STX | SEQ | DATA LENGTH | DATA | CRC-16 | ETX |
|---|---|---|---|---|---|
| 1 | 1 | 3 | 3-999 | 5 | 1 |

Format of Response Packet

| STX | SEQ | DSP | PRV | ETX |
|---|---|---|---|---|
| 1 | 1 | 1 | 1 | 1 |

Format of Synchronization Response Packet

| STX | MTS | MRS | ETX |
|---|---|---|---|
| 1 | 1 | 1 | 1 |

Legend for Figures

| | |
|---|---|
| STX | Start of Packet Character |
| SEQ | Sequence # (Cycles from ‘0’ thru ‘9’) |
| LEN | Length of Data Area (‘003’ thru ‘999’) |
| DATA | ASCII Data Fields Separated with ‘\|’ Character |
| CRC | CRC-16 Value (‘0000’ thru ‘65535’) Cyclic Redundancy Check |
| ETX | End of Packet Character |
| DSP | Disposition Code (‘A’ ACK, ‘N’ NAK, or ‘I’ Invalid Sequence) |
| PRV | Sequence Number of Last ACK'ed Packet (0 thru 9) |
| MTS | Main's Current Transmit Sequence Number |
| MRS | Main's Current Receive Sequence Number |

The Command Packet and Response Packet are used during primary game communications. The protocol uses redundant acknowledgement. For example: The packet is initially acknowledged when first received by the recipient. The same recipient will resend anther acknowledgement in the next communication. This second acknowledgement is the ‘PRV’ data in the response packet.

The communications between the Game Engine and the Player Station intelligence is preferably a transaction-based protocol. Either device can start a transaction, which is why it is essential that there be an intelligent board at each player position. All packets of information may be sent in any acceptable format, with ASCII format preferred as a matter of designer choice. All command packets usually contain a sequence number that is incremented after each successful packet exchange. The Game Engine and the Player Station intelligence use sequence numbers that are independent of each other. The sequence number keeps the communications in synchronization. This synchronization method is described later.

The command packet is used to send various commands such as Inputs, Lamps, Doors, Errors, Chirp, Game Results, player input, coin acceptance, player identification, credit acceptance, wagers, etc. . . . The command packet format may be, by ay of a non-limiting example:
<STX><Sequence number><Data Length><Data><CRC-16><ETX>

The data format with in the command packet may be:
<Address><Command><Field 1>|<Field 2>|<Field n>|
The response packet format may be:
<STX>Sequence number><Disposition><Previous ACK><ETX>
The sync request packet format may be:
<SYN>
The sync response packet format may be:
<STX><Mains Current Transmission Sequence><Mains Current Receive Sequence><ETX>
A major strength of the protocol is its resilience of the Game Protocol and its ability to free up resources within the game engine. Those resources can in turn be used to provide more intricate games, and multi-media affects.
Synchronization Method:

The satellite and host must become synchronized in order to provide for reliable communications using packet numbers. To facilitate this, a novel protocol synchronization method that is used. Upon applying power to the satellite, or after a communications failure, the satellite automatically enters into synchronization mode. In the synchronization mode the satellite sends out the ASCII SYN (0x16) character about every second. It is expecting a special response packet containing transmit and receive packet sequence numbers to be used from that point on. After receiving the special response packet, the sequence numbers are used as-is, and not incremented until a successful packet exchange is completed. After communications is synchronized, the sequence numbers are incremented after each packet is successfully sent or received. As was noted before, the main game processor may contain information, data, programming and other necessary functions to enable the play of multiple games off the same machine. For example, the main game engine may have rules and commands that will enable play of high and low games of the present invention and other card games. The system may be controlled so that different games may be played at different times on command of the casino or players.

Further examples and embodiments of the game according to the present invention are described in further detail herein below. In these embodiments, the game will be primarily described with respect to the game of blackjack (and its variations such as Spanish 21™), but as described in greater detail, the award or bonus event is applicable to other variants of blackjack, other card games or other types of gambling games.

In preferred embodiments of the present invention, an optional or mandatory side bet wager is made and the bonus award may be won on the basis of any defined event occurring in the play of the blackjack game, including, but not limited to, any of events in the player's 2-card hand, the dealer's up-card, the combination of the player's 2-card hand and the dealer's up-card, combinations of less than all the player's 2-card hand and the dealer's up-card, player's final hand, dealer's final hand, comparisons between player's initial 2-card hand and the dealer's initial 2-card hand (usually determined at the end of play or when the dealer's hand is revealed), differences between the player's final hand and the dealer's final hand (e.g., final point spread) and the like.

For example, the defined event can be events that are selected from at least specific hands of:
Ace and King of the same suit (Payout at 25 to 1)
Ace and Queen of the same suit (Payout at 20 to 1)
Ace and Jack of the same suit (Payout at 15 to 1)
Ace and 10 of the same suit (Payout at 10 to 1)
Any blackjack with cards (Ace and 10-count card) of different suits (Payout at 5 to 1), and
Any (hard or soft) count of 20 (Payout at 2 to 1).
   Many other combinations or events that can occur in blackjack or other games can be used as the bonus award.

Once the bonus award by the player or other player making the side bet bonus wager has been determined based on comparison with the criteria for receiving the bonus award, other events involving the dealer's hand are then analyzed to see if the events in the dealer's hand modifies the bonus win. This modification may increase or decrease the bonus award.

Among the events that might be used to change the bonus amount won by the player could be the dealer eventually busting according to the ordinary rules of play, the dealer having a blackjack, the dealer having a suited blackjack, the dealer having a particular (e.g., only Spades, only red cards, only black cards, only with Jacks, only with 10s, etc.) blackjack, the dealer having a 6-7-8 straight, the dealer having identically paired two first cards (e.g., 2×6's of Hearts), a pair on the first two cards, a count of 20 on the first two cards, two face cards on the two first cards, a particular card as the up-card (e.g., the Ace of Spades as the Dealer up-card), a particular suit as the up-card, the player's two-card hand and the dealer's up-card forming a straight or flush, etc. One characteristic that may be used in describing at least some of the embodiments of this invention is that the player has won the bonus, and then some event involving the dealer's hand or cards in the dealer's hand is used to change the player's previously won bonus. This can be done without directly affecting play in the underlying game. For example, even though the change in the bonus is preferably based upon the dealer busting, the play of the dealer's hand follows the strict rules of blackjack, and the presence or absence of a bonus side bet wager or the player having already won the bonus does not affect the play of the dealer's cards.

In more generic terms, the bonus event of the present invention may be described as playing an underlying game with a player and at least one of a dealer's hand (in a club game, the hand designated as the dealer, playing according to standard or variant dealer rules of play) or a bonus hand (which again should be played according to dealer's rules when the defining event is a bust in blackjack or some other adverse result in the play of the hand). The player makes a side bet bonus wager on the occurrence of an event in the underlying game.

The event in the underlying game is preferably an event specific to that player's hand, although it may be specific to a particular player's hand at the table (e.g., the first base hand, the third base hand, etc.) and even a combination with a specific hand and the dealer's up card or initial hand. The play of the underlying game should be unaffected by the occurrence of the event. The player then is determined to have won a bonus when that player has made the side bet bonus wager and the event has occurred. If a second event defined as modifying the bonus can be determined at this point (e.g., the player's up-card being the Ace of Spades or other identified card), the player's bonus can be paid off, even at the modified amount, at this time. If the second event defined as modifying the bonus cannot be determined at this point (e.g., the dealer busting, the dealer having a blackjack of a particular type, etc.), the underlying game will continue to play before the bonus is paid. Once the occurrence or non-occurrence of the second event has been determined, the side bet wager bonus can be paid out appropriately.

In allowing potential variations, the house may adjust the probabilities in its favor by excluding or defining events that can be used within the play of the bonus event. For example, the splitting of player's cards may be excluded from bonus events, included in bonus events, or restricted under specific events, such as where the first two cards are Aces or cards with counts of 10 (i.e., 10's, Jacks, Queens and Kings). This would still allow the underlying bonus and bonus changer to possibly benefit the player.

It should be noted that changing a due or won bonus, paid before the final outcome of the game, based upon subsequent events, particularly subsequent events relating to the dealer's hand in a game of blackjack, is a feature of the preferred embodiments of the present invention. These and other aspects of play will be even better appreciated by a review of the following examples. It is to be further noted that although the blackjack example shows a single paytable for the bonus as well as a single second event (i.e., dealer busting), these examples are not intended to be limiting, but rather provide specific support for the generic principles of the game according to the present invention.

The following single paytable contains the winning criteria and preset formulas used in the following examples to determine whether an intermediate or bonus award should be granted at an intermediate or bonus event and the amount to be awarded based upon the side bet bonus wager:
Ace and King of the same suit (Payout at 25 to 1)
Ace and Queen of the same suit (Payout at 20 to 1)
Ace and Jack of the same suit (Payout at 15 to 1)
Ace and 10 of the same suit (Payout at 10 to 1)
Any blackjack with cards (Ace and 10-count card) of different suits (Payout at 5 to 1), and
Any (hard or soft) count of 20 (Payout lt 2 to 1).

The criteria for subsequent modification of the award at subsequent intermediate stages or upon final outcome of the underlying game are explained in each game.

Exemplary Game 1

In a blackjack game according to the present invention, the player makes an underlying blackjack wager of $10 and a side bet wager of $5. An award modification in the present example is available if the player satisfies any of the first winning criteria in the intermediate action listed in the paytable above and the dealer busts at the final outcome of the game. If this second criteria is met for an award modification, the player's intermediate award is modified by a second formula that comprises adding an absolute amount of 10× the side bet wager, which in the present example would be 10× $5 or $50. The initial hands are shown below:

| | |
|---|---|
| Player's Hand | Dealer's Up-Card |

| | | |
|---|---|---|
| Ace♦ | Jack♥ | 9♥ |

Since the player's hand satisfies one of the criteria described in the paytable above (i.e., “Any blackjack with cards of different suits”), the player has won the bonus award of $25 (5× the side bet amount of $5) according to the formula in the paytable (i.e., “Payout at 5 to 1”) associated with this criteria. After the intermediate action is concluded, the game proceeds and dealer's hole card is revealed to show hands as follows:

| | |
|---|---|
| Player's Hand | Dealer's Hand |

| | | | |
|---|---|---|---|
| Ace♦ | Jack♥ | 9♥ | 6 [symbol] |

The dealer's hand has a cumulative value of 15. Thus, the dealer must hit according to the normal rules of blackjack play. The dealer's receives a 4 [symbol] for a total value of 19 based on a hand consisting of 9♥ 6 [symbol] 4 [symbol] . This is the final outcome according to the rules of blackjack. Although the first criteria for receiving an intermediate award were satisfied, the second criteria for receiving a modification to that award were not. Thus, the player's final award is the same as the intermediate award of $25. It should be noted that this award is in addition to any payout to the player based on winning the underlying game of blackjack, which is typically a win of 3/2 on the blackjack hand (i.e., $10 bet yields $15 on a blackjack).

Exemplary Game 2

In a blackjack game according to the present invention, the player makes an underlying blackjack wager of $10 and a side bet wager of $5. As in the previous example, an award modification can be obtained if the player satisfies any of the winning criteria in the intermediate action shown in the paytable above and the dealer busts. If these criteria are met, the formula for an award modification comprises doubling the intermediate award. The initial hands are shown below:

| | |
|---|---|
| Player's Hand | Dealer's Up-Card |

| | | |
|---|---|---|
| Ace♥ | Jack♥ | 9♥ |

Since the player's hand satisfies one of the criteria described in the paytable above (i.e., “Ace and Jack of the same suit”), the player has won the bonus award of $75 (15× the side bet amount of $5) according to the formula in the paytable (i.e., “Payout at 15 to 1”) associated with this criteria. After the intermediate action is concluded, the game proceeds and dealer's hole card is revealed to show hands as follows:

| | |
|---|---|
| Player's Hand | Dealer's Hand |

| | | | |
|---|---|---|---|
| Ace♥ | Jack♥ | 9♥ | 6 [symbol] |

The dealer's hand has a cumulative value of 15. Thus, the dealer must hit according to the normal rules of blackjack play. The dealer receives a 7 [symbol] for a cumulative hand value of 22 and the final outcome of the game is that the dealer busts. Thus, the second bonus event criteria is satisfied which results in an award modification according to the rules above. The final award to the player is $150 (i.e., the intermediate award of $75 multiplied by 2×) plus the 3/2 on the blackjack in the underlying game.

Exemplary Game 3

In a blackjack game according to the present invention, the player makes an underlying blackjack wager of $10 and a side bet wager of $5. As in the previous example, an award modification can be obtained if the player satisfies any of the winning criteria in the intermediate action shown in the paytable above and the dealer busts with a cumulative value of 26. If these criteria are met, the player receives an award modification which is the intermediate award plus an increase of 10× the underlying blackjack wager. In the present example, this increase would be $100. The initial hands are shown below:

| | |
|---|---|
| Player's Hand | Dealer's Up-Card |

| | | |
|---|---|---|
| Ace♥ | Jack♥ | 9♥ |

Since the player's hand satisfies the “Ace and Jack of the same suit” criteria, the player has won the bonus award of $75. After the intermediate action is concluded, the game proceeds and dealer's hole card is revealed to show hands as follows:

| | |
|---|---|
| Player's Hand | Dealer's Hand |

| | | | |
|---|---|---|---|
| Ace♥ | Jack♥ | 9♥ | 6 [symbol] |

After the dealer hits, the dealer's hand consists of 9♥ 6 [symbol] 7 [symbol] for a value of 22. Thus, the final outcome is a dealer bust. However, since the dealer busts without a cumulative value of 26, the intermediate award is not modified. The player receives an award of $75 plus the 3/2 on the blackjack in the underlying game.

Exemplary Game 4

In an underlying game of blackjack according to the present invention, the player makes an underlying blackjack wager of $20 and a side bet wager of $10. The second event bonus increasing rule is that there is a halving of the bonus won if the dealer has a suited blackjack and a doubling of the bonus if the dealer busts. The initial hands are shown below:

| Player's Hand | Dealer's Up-Card |
|---|---|
| Ace♥ Jack♥ | Ace♥ |

Thus, the player has satisfied the first criteria and is awarded $150 according to the above paytable. The dealer's hole card is revealed to form the following hands:

| Player's Hand | Dealer's Hand |
|---|---|
| Ace♥ Jack♥ | Ace [symbol] Jack [symbol] |

The dealer declares a dealer blackjack. The dealer's hand is a suited blackjack, so the intermediate bonus award won is halved to $75. The final award becomes 15×$10.00 divided by 2 because the dealer had a suited blackjack plus nothing on the blackjack in the underlying game because the dealer also had a blackjack.

Exemplary Game 5

In an application of the bonus increasing event described herein applied to Let It Ride® poker, there is a standard side bet for ranked hands for the player, and a second side bet where the bonus can be increased either a fixed amount or by a multiplier (e.g., 2×) when the dealer's hand is a defined event, which might by suited Ace and a royalty or honor card (King, Queen, Jack or 10), which is not in itself material to the rank or play of the Let It Ride® game. In the event that a player gets a ranked bonus hand (e.g., three-of-a-kind, straight, flush, full house, four-of-a-kind or straight flush) and the dealer's hand is a suited Ace and Honor, the bonus award on the ranked hand is doubled. Again, the bonus may add an absolute amount to the bonus won or a multiple of the second side bet wager amount.

Exemplary Game 6

In an underlying game of blackjack of the present invention, the player makes an underlying blackjack wager of $10 and a side bet wager of $5. In this embodiment, there is a second intermediate action. The criteria for the first intermediate action is shown in the paytable above. To win the second intermediate bonus event the player must have won the first intermediate action with a suited event and the dealer up-card must be the same suit as the player's suited event. The award modification resulting from the second intermediate action is a tripling of the intermediate award. The initial hands are shown below.

| Player's Hand | Dealer's Up-Card |
|---|---|
| Ace♥ Jack♥ | 9♥ |

Accordingly, the player has satisfied the first and second intermediate winning criteria and won the bonus award of $225 (3×$75). In this embodiment, the dealer does not have to proceed to show both cards to make a determination of the final outcome of the second intermediate action. Although allowed by the present invention, this game does not include an award modification upon the final outcome of the game (e.g., doubling of the award if the dealer busts). Thus, the play of the dealer's cards have no consequence on the final award according to the aforementioned second rules. The second criteria are satisfied and the player receives $225 plus the 3/2 on the blackjack in the underlying game. The blackjack game is then played to conclusion for any other players at the table.

One additional point that may be noted at this stage of the description is that there may be circumstances in the play of the blackjack hand where the dealer is ordinarily not required to take any hits, even if the dealer's count is 16 or less. For example, every preceding player has busted or obtained a blackjack. If there is even a single player that has won a bonus and the second bonus increasing even is the dealer busting, the rules may either require the dealer to continue taking hits according to normal rules, or prevent taking any hits, as hits cannot affect the underlying events in the blackjack game. It is preferred from a relationship standpoint with players to require the dealer to hit to at least a count of 17.

In the above description, variations within the generic principles of the invention have been alluded to or described. One of ordinary skill in the art can develop other alternatives or additions within the scope of the invention. For example, special wagering features such as coin accepting slots, proximity detectors, or other wager indicators (particularly for the side bet wager) can be provided on the gaming table for the play of the exemplary blackjack game. Progressive bonuses may be designed for use with the appearance of special hands (e.g., dealer and player matching suited blackjacks or the like). Such a progressive bonus may be indicated on a special meter. Other options and components may be added to the play of the game without avoiding the underlying generic concepts disclosed in this description and the claims of the invention.

For example, the underlying game could be another casino-style card game such as baccarat, pai gow poker, or a specialty poker game such as Let it Ride® Stud Poker, Caribbean Stud® poker, for example. In the case of Let it Ride® poker used in an above example, players each receive 3 cards, face down after placing three equal bets. The dealer receives two cards, face down, that serve as common cards for all players. The players are given a chance to view their cards, and are given the option of taking back one of the bets. The dealer turns over the first community card, and the players are then given the opportunity to take back a second one of the bets. The third bet must remain up. The dealer then reveals his second community card, and each player's hand of three cards plus the two community cards is resolved against a pay table. The pay table shows payout odds for each of a predetermined group of winning hands. A side bet of the present invention could be made available for the appearance of one, two, three or four cards of the same cards, i.e.—Jacks, either from the player hand, the dealer common cards or a combination thereof. It is preferred that the layout be modified so that the player's three cards appear on a given area of the layout, and that the order in which the cards are dealt cannot be modified.

In another example, the underlying game is Pai Gow poker. Each player and the dealer receive 7 cards. The players and the dealer “set” their hands, forming a five card hand and a two card hand. A side bet on the occurrence of a designated card, such as a King in the player's two card hand and/or the dealer's 2 card hand could be offered. Or, the designated card may be in the five card hands, or combinations of the five and two card hands. Other casino games such as Baccarat could be played in a manner similar to the blackjack game described in detail above.

Although exemplary and preferred aspects and embodiments of the present invention have been described with a full set of features, it is to be understood that the disclosed system and method may be practiced successfully without the incorporation of each of those features. It is to be further understood that modifications and variations may be utilized without departure from the spirit and scope of this inventive system and method, as those skilled in the art will readily understand. Such modifications and variations are considered to be within the purview and scope of the appended claims and their equivalents.

What is claimed is:

1. A method of playing a game having an award modifying feature comprising the steps of:
a) wagering a monetary amount on a card game involving a player playing against a dealer;
b) playing the card game until an intermediate condition is reached, wherein the intermediate condition includes providing the player and the dealer with one or more cards to form a player's intermediate hand and a dealer's intermediate hand, respectively;
c) providing an intermediate award to the player if the player's intermediate hand satisfies one or more first predefined criteria, wherein the intermediate award is determined by a predetermined set of rules;
d) playing the card game until a final outcome is reached, wherein upon reaching the final outcome the player forms a player's final hand and the dealer forms a dealer's final hand; and
e) modifying the intermediate award to provide a final award if the dealer's final hand satisfies one or more second predefined criteria, wherein the relationship between the final award and the intermediate award is determined by one or more mathematical formulas associated with at least the second satisfied predefined criteria.

2. The method according to claim 1, wherein the step of wagering a monetary amount on a card game involving a player playing against a dealer further includes wagering a first amount having an outcome dependent on satisfying the first predefined criteria in the intermediate condition and wagering a second amount having an outcome dependent on the final outcome of the game.

3. The method according to claim 2, wherein the step of providing an intermediate award to the player if the player's intermediate hand satisfies one or more first predefined criteria, wherein the intermediate award is determined by a predetermined set of rules, further includes:
determining if the player's intermediate hand is equivalent to an automatic winning blackjack hand comprising an ace card and a second card having a numerical value of ten in accordance with the rules of blackjack; and
determining the rank and suit of the cards in the player's intermediate hand.

4. The method according to claim 3, wherein the one or more first predefined criteria are satisfied if the player's intermediate hand is determined to be a winning blackjack hand comprising an ace and a second card of the same suit.

5. The method according to claim 3, wherein the one or more first predefined criteria are satisfied if the player's intermediate hand is determined to be a winning blackjack hand.

6. The method according to claim 5, wherein the step of providing an intermediate award to the player if the player's intermediate hand satisfies one or more first predefined criteria, wherein the intermediate award is determined by a predetermined set of rules, further includes determining the intermediate award by multiplying the first amount by a predetermined multiplier according to the rank of the second card in the player's intermediate hand.

7. The method according to claim 6, wherein the predetermined multiplier is determined according to a payout table.

8. The method according to claim 7, wherein the payout table comprises:

| Player's intermediate hand | Payout |
|---|---|
| Ace and King of the same suit | 25 to 1 |
| Ace and Queen of the same suit | 20 to 1 |
| Ace and Jack of the same suit | 15 to 1 |
| Ace and 10 of the same suit | 10 to 1 |
| Any blackjack | 5 to 1 |

9. The method according to claim 6, wherein the step of playing the card game until a final outcome is reached, wherein upon reaching the final outcome the player forms a player's final hand and the dealer forms a dealer's final hand, further includes playing a game of blackjack until a final outcome is reached and the player's final hand and the dealer's final hand are formed.

10. The method according to claim 9, wherein the step of modifying the intermediate award to provide a final award if the dealer's final hand satisfies one or more second predefined criteria, wherein the relationship between the final award and the intermediate award is determined by one or more mathematical formulas associated with at least the second satisfied predefined criteria, further includes modifying the intermediate award if the cumulative numerical value of the dealer's final hand is greater than twenty-one.

11. The method according to claim 10, wherein the final award is double the monetary value of the intermediate award.

12. The method according to claim 9, wherein the step of modifying the intermediate award to provide a final award if the dealer's final hand satisfies one or more second predefined criteria, wherein the relationship between the final award and the intermediate award is determined by one or more mathematical formulas associated with at least the second satisfied predefined criteria, further includes modifying the intermediate award if the cumulative numerical value of the dealer's final hand is equal to twenty-six.

13. The method according to claim 12, wherein the final award is a multiple of the monetary value of the intermediate award.

14. The method according to claim 1, wherein the step of wagering a monetary amount on a card game involving a player playing against a dealer further includes wagering a first amount having an outcome dependent on satisfying the first predefined criteria in the intermediate condition, wagering a second amount having an outcome dependent on the final outcome of the game and wagering a third amount having an outcome dependent on the player's intermediate hand having a cumulative value of either twenty or twenty-one in accordance with the rules of blackjack.

15. The method according to claim 14, further comprising the step of providing an additional award being twice the value of the third amount if the player's intermediate hand has a cumulative value of either twenty or twenty-one.

16. The method according to claim 15, wherein the step of playing the card game until a final outcome is reached, wherein upon reaching the final outcome the player forms a player's final hand and the dealer forms a dealer's final hand, further includes playing a game of blackjack until a final outcome is reached and the player's final hand and the dealer's final hand are formed.

17. The method according to claim 16, wherein the step of modifying the intermediate award to provide a final award if the dealer's final hand satisfies one or more second predefined criteria, wherein the relationship between the final award and the intermediate award is determined by one or more mathematical formulas associated with at least the second satisfied predefined criteria, further includes multiplying the intermediate award if the cumulative numerical value of the dealer's final hand is greater than twenty-one and multiplying the additional award by two.

18. A method of playing a game according to claim 1, wherein the card game is blackjack.

19. A method of playing a game according to claim 1, wherein the card game is baccarat.

20. A method of playing a game according to claim 1, wherein the card game is a poker-type game.

21. A method of playing a wagering card game comprising an underlying card game comprising blackjack and an auxiliary card game comprising:
placing at least one wager on the underlying blackjack game;
placing a wager on the auxiliary card game;
dealing two cards to a player in the blackjack game;
dealing two cards to a dealer hand;
displaying the player's cards to determine if the auxiliary card game has been won according to the rules of the auxiliary game; and
wherein if the two cards dealt to the player wins an amount in the auxiliary card game and the dealer's hand satisfies a predefined event, the amount the player wins in the auxiliary card game is changed.

22. The method of claim 21 wherein the predefined event comprises the dealer busting.

23. The method of claim 21 wherein the predefined event is a suited event in the dealer's hand.

24. The method of claim 21 wherein the predefined event is a suited blackjack in the dealer's hand.

25. The method of claim 22 wherein the amount won in the auxiliary card game is increased by the predefined event being achieved.

26. The method of claim 22 wherein the auxiliary card game is a bonus event.

27. The method of claim 23 wherein the auxiliary card game is a bonus event.

28. The method of claim 26 wherein the amount won is defined according to a table comprising:
Ace and King of the same suit (Payout at 25 to 1)
Ace and Queen of the same suit (Payout at 20 to 1)
Ace and Jack of the same suit (Payout at 15 to 1)
Ace and 10 of the same suit (Payout at 10 to 1)
Any blackjack with cards (Ace and 10-count card) of different suits (Payout at 5 to 1), and
Any (hard or soft) count of 20 (Payout 1t 2 to 1).

29. The method of claim 27 wherein the amount won is defined according to a table comprising:
Ace and King of the same suit (Payout at 25 to 1)
Ace and Queen of the same suit (Payout at 20 to 1)
Ace and Jack of the same suit (Payout at 15 to 1)
Ace and 10 of the same suit (Payout at 10 to 1)
Any blackjack with cards (Ace and 10-count card) of different suits (Payout at 5 to 1), and
Any (hard or soft) count of 20 (Payout 1t 2 to 1).

30. The method of claim 25 wherein the increase comprises the addition of an absolute amount to the amount the player wins.

31. The method of claim 25 wherein the increase comprises multiplying the amount the player wins.

32. The method of claim 21 played on an electronic gaming system.

33. A machine readable media for facilitating a method of playing a game having an award modifying feature, comprising:
a) a data segment for,
i) storing game data relating to a card game in which players play against a dealer having a predefined intermediate condition and a final outcome;
ii) storing wagering data relating to a monetary amount wagered on a card game involving a player playing against a dealer in an wagering database;
iii) storing intermediate condition data relating to an intermediate predefined criteria and a mathematical formula for calculating the appropriate intermediate award; and
iv) storing final outcome data relating to a final predefined criteria and a mathematical formula for calculating the appropriate modification to the intermediate award;
b) a code segment for,
i) playing the card game until the predefined intermediate condition is reached;
ii) determining if an intermediate award is appropriate based on whether a predefined intermediate criteria is satisfied;
iii) playing the card game until the final outcome is reached;
iv) determining if the intermediate award should be modified based on whether a final predefined criteria is satisfied at the final outcome; and
v) modifying the intermediate award based on the determination.

34. A multi-player platform that provides multiple player positions for live players to engage in a blackjack game having an award modifying feature with a virtual dealer and virtual cards comprising at least two player positions that enable live players to place wagers on the game, a display system for showing a virtual dealer, a display system for showing the virtual cards used in play of the game, and a database that contains the rules of the game, the processor enabling play for each player on the blackjack game according to the rules in the database, wherein the game comprises the steps of:
a) wagering a monetary amount;
b) playing the card game until an intermediate condition is reached, wherein the intermediate condition includes providing a player and the dealer with one or more cards to form a player's intermediate hand and a dealer's intermediate hand, respectively;
c) providing an intermediate award to a player if the player's intermediate hand satisfies one or more first predefined criteria, wherein the intermediate award is determined by a predetermined set of rules stored in the database;
d) playing the card game until a final outcome is reached, wherein upon reaching the final outcome the player forms a player's final hand and the dealer forms a dealer's final hand; and
e) modifying the intermediate award to provide a final award if the dealer's final hand satisfies one or more second predefined criteria stored in the database, wherein the relationship between the final award and the intermediate award is determined by one or more mathematical formulas stored in the database and associated with at least the second satisfied predefined criteria.

35. The platform of claim 34, wherein the step of wagering a monetary amount further includes wagering a first amount having an outcome dependent on satisfying the first predefined criteria in the intermediate condition and wagering a second amount having an outcome dependent on the final outcome of the game.

36. The platform of claim 35, wherein the step of providing an intermediate award to the player if the player's intermediate hand satisfies one or more first predefined criteria, wherein the intermediate award is determined by a predetermined set of rules, further includes:
determining if the player's intermediate hand is equivalent to an automatic winning blackjack hand comprising an ace card and a second card having a numerical value of ten in accordance with the rules of blackjack; and
determining the rank and suit of the cards in the player's intermediate hand.

37. The platform of claim 36, wherein the one or more first predefined criteria are satisfied if the player's intermediate hand is determined to be a winning blackjack hand comprising an ace and a second card of the same suit.

38. The platform of claim 37, wherein the step of providing an intermediate award to the player if the player's intermediate hand satisfies one or more first predefined criteria, wherein the intermediate award is determined by a predetermined set of rules, further includes determining the intermediate award by multiplying the first amount by a predetermined multiplier according to the rank of the second card in the player's intermediate hand.

39. The platform of claim 38, wherein the predetermined multiplier is determined according to a payout table.

40. The method according to claim 39, wherein the payout table comprises:

| Player's intermediate hand | Payout |
|---|---|
| Ace and King of the same suit | 25 to 1 |
| Ace and Queen of the same suit | 20 to 1 |
| Ace and Jack of the same suit | 15 to 1 |
| Ace and 10 of the same suit | 10 to 1 |
| Any blackjack | 5 to 1 |

41. A system for playing a game having an award modifying feature comprising:
a) a database for storing game data relating to the rules of a card game, a first predefined criteria including a first predetermined set of rule relating to an intermediate award payment amount, a second predefined criteria including a mathematical formula for determining an award modification;
b) a processor for
i) playing the card game until an intermediate condition is reached, wherein the intermediate condition includes providing the player and the dealer with one or more cards to form a player's intermediate hand and a dealer's intermediate hand, respectively;
ii) determining if the first predefined criteria is satisfied;
iii) determining the intermediate award based on the predetermined set of rules if the first predefined criteria is satisfied;
iv) playing the card game until a final outcome is reached, wherein upon reaching the final outcome the player forms a player's final hand and the dealer forms a dealer's final hand;
v) determining if the second predefined criteria is satisfied;
vi) calculating the modification to the intermediate award using the mathematical formula if the second predefined criteria;
c) a user interface for receiving wagers from the players, communicating the game play to the players and distributing the award to players.

42. The system of claim 41, wherein the user interface is configured to operate over the world wide web to permit the players to play the card game using the world wide web.

43. The system of claim 41, wherein the card game is blackjack.
